(19) United States
(12) Patent Application Publication
(10) Pub. No.: US 2005/0198061 A1
(43) Pub. Date: Sep. 8, 2005

(54) Process and product for selectively processing data accesses

(76) Inventors: David Robinson, Lakeland, FL (US); Victor Garcia, Lakeland, FL (US)

Correspondence Address: V. Garcia;IMPULSE, Suite 400, 6810 New Tampa Highway, Lakeland, FL, 33815, US

(21) Appl. No.: 11/059,812

(22) Filed: Feb. 17, 2005

Related U.S. Application Data
(63) Continuation-in-part of application No. 10/945,242, filed on Sep. 20, 2004.
(63) Continuation-in-part of application No. 10/971,671, filed on Oct. 22, 2004.
(60) Provisional application No. 60/545,093, filed on Feb. 17, 2004.
(60) Provisional application No. 60/551,893, filed on Mar. 10, 2004.

(51) Int. Cl. G06F 17/00

(52) U.S. Cl. 707/102

(57) ABSTRACT

In a method according to an embodiment of the invention, it is determined whether there is an attempt by a device to access data representing music. If there is such an attempt by the device one of various actions may be performed, such as providing an offer to purchase an item. Determining whether there is such an attempt by the device may include reading data and determining whether the read data includes data representing music.

This application is
(a) a continuation in part of U.S. patent application Ser. No. 10/945,242, filed on Sep. 20, 2004 for “METHOD AND APPARATUS FOR HANDLING ATTEMPTS BY A DEVICE TO ACCESS CERTAIN DATA”; and
(b) a continuation in part of U.S. patent application Ser. No. 10/971,671, filed on Oct. 22, 2004 for “APPARATUS AND PROCESS FOR SELECTIVELY PROCESSING DATA ACCESSES;
   where all of the above applications are incorporated herein by reference; and
   this application claims the benefit of priority of
(i) provisional patent application no. 60/545,093, filed on Feb. 17, 2004 for “SYSTEM AND METHOD FOR ELECTRONIC DATABASE FILE ACCESS MONITORING AND CONTROL”;
(ii) provisional patent application no. 60/551,893, filed on Mar. 10, 2004 for “SYSTEM FOR PROVIDING SUCCESSIVE OFFERS”;
   each such provisional application being incorporated herein by reference.

### BACKGROUND

A number of different kinds of information, including music files and video files, can be easily copied to/by various kinds of computing devices, such as personal computers, media players and servers connected to the Internet. This functionality may not be desirable, such as where an unauthorized copy is made of a copyrighted work.

### BRIEF DESCRIPTION OF THE DRAWINGS

FIG. 1 depicts an overview of an embodiment of the invention.

FIG. 2 depicts a network of an embodiment of the invention.

FIG. 3 depicts another network of an embodiment of the invention.

FIG. 4 depicts an overview of an embodiment of the invention.

### DETAILED DESCRIPTION

The present invention includes a diverse array of embodiments, and the embodiments need not be mutually exclusive. The various embodiments are applicable to a wide variety of environments and problems. One of ordinary skill in the art may appropriately select a disclosed embodiment, or may easily modify the teachings of the explicitly disclosed embodiments, as desired, in order to meet specific goals and constraints.

The vast number of embodiments disclosed herein are due to the pioneering nature of the inventors' contributions.

1. Overview of Certain Embodiments

The embodiments presented in this Section 1 are provided only for purposes of illustration and introduction to the disclosure of the present application. They are not to be considered as limiting the scope of the invention in any manner.

A file being downloaded or copied by a personal computer, server, media player or other device (e.g., downloaded or copied from a peer-to-peer file sharing network using a program such as Kazaa® by Sharman Networks Ltd, downloaded or copied as an email attachment, downloaded or copied from an FTP site, downloaded or copied from a “BitTorrent” network using a “BitTorrent” client program, copied from a peripheral device such as a CD drive or DVD drive) may be determined to include “qualifying data”, such as an MP3 file of music that has not been legally obtained (e.g., the music file is copied without appropriately compensating the copyright owner). Qualifying data may be defined in various ways, as desired, such as data representing music, certain music, video, certain video, a written work, a book or article, certain books or articles, software programs, certain software programs, copyrightable works, certain copyrightable works.

Software which is executed (e.g., by the personal computer) may identify the music as copyrighted, e.g., by comparing some or all of its contents to a database that stores or identifies a variety of copyrighted music (e.g., a database of all songs that are provided by Sony Music USA [symbol] ). The software may further identify the music as not having been legally purchased, e.g., by determining that (i) the music is copyrighted but (ii) the music file lacks appropriate digital rights management (“DRM”) or other indicia of legal acquisition. The software may additionally or alternatively compare the music to a copy which is known to not have been legally purchased (e.g., by comparing the music to a copy which is available from a peer-to-peer sharing network, and determining that the music is a substantial match for that copy).

In response (e.g., in response to determining that the music has not been legally purchased), the software which is executed (e.g., by the personal computer) can provide the user with an offer (e.g., an offer to purchase the music legally). For example, a web browser such as Microsoft's Internet Explorer® may execute and may display text such as “You appear to be downloading an unlicensed copy of ‘Badlands’ by Bruce Springsteen. Would you like to purchase an authorized copy of that song?”

If this offer s accepted, the user is provided with an opportunity to legally purchase the music. For instance, a web browser or like software can be automatically directed to access a web page (e.g., http://musicdownloads.walmart.com) of a merchant that sells the music. In addition or in the alternate, a web browser or like software can be provide a link to a web page (e.g., http://musicdownloads.walmart.com) of a merchant that sells the music.

Thus, in the embodiment described above, the user who (intentionally or unintentionally) acquires music illegally (e.g., in violation of copyright law) is provided with an opportunity to rectify the illegal act by purchasing the same music legally.

In various embodiments, the software does not brashly intrude by preventing a user from acting illegally. The user can retain the freedom to choose whether to continue in the illegal activity. Thus the software will not be subject to the same attacks and criticism as would software that imposed more stringent restrictions on the user, such as preventing downloads altogether.

An advantage of the embodiment described above is the utilization of demand information which the user exhibits (i.e. by copying the music file to his personal computer, the demand for songs as opposed to demand for an album, the demand for what people are interested in as opposed to what people are willing to pay retail price for). This demand is used to create a sales opportunity (e.g., by offering to sell that music) or other promotional opportunity (e.g., by offering to play another song, by providing advertising, by providing the user with a warning, by providing the user with an informational message). This demand information has never been used to create a sales opportunity at the time of copying, much less to create an opportunity to sell music at the time when that music is being illegally copied/acquired.

Such demand information is revealed from analyzing activities of, e.g., the personal computer which copies the information. Accordingly this information is typically inaccessible to merchants. Thus this demand information is not readily utilized for anything, much less direct and immediate sales opportunities.

In the example embodiment described above, the software that is executed (e.g., by the personal computer) can provide (in whole or in part) the above-described functionality of providing an appropriate offer at an advantageous time. Embodiments of the invention can help assure that such software continues to function unimpeded (e.g., continues to provide appropriate offers at advantageous times). For example, a network access provider (e.g., an Internet service provider, a network administrator of a LAN or WAN, an administrator of a Virtual Private Network) can require that the software continues to execute unimpeded. For example, the network access provider may periodically monitor the personal computer to determine the presence and “health” of that software. If the network access provider determines, e.g., that the software is not executing and/or has been altered, the network access provider can respond by taking any of many actions, such as denying network resources to the personal computer (e.g., deny Internet access to the personal computer).

1.1. Various Environments

In embodiments of the invention, various functionality that is described herein may be performed by software executed by a computer or like device (e.g., a personal computer which attempts to access qualifying data, a personal computer which stores qualifying data). Such software may include application software, utility software and/or device drivers.

In other embodiments, such software may reside on another computer (e.g., a server). When executed, the software performs various functionality on one or more connected computers (e.g., personal computers which rely on the server for various resources).

In other embodiments, various functionality described herein may be performed by software executed by other devices such as cellular telephones, audio players, MP3 players (e.g., a cellular telephone which attempts to access qualifying data, an MP3 player which stores qualifying data), personal digital assistants, handheld computer devices, handheld systems and game consoles.

In other embodiments, various functionality described in this application may be performed by software, firmware and/or embedded hardware, such as a ROM storing certain instructions.

In other embodiments, various functionality described in this application may be performed, in whole or in part, by peripheral device in communication with the device that is, e.g., attempting to access qualifying data, storing qualifying data, copying qualifying data.

In other embodiments, various functionality described herein may be performed, in whole or in part, by media readers or media writers, such as CD-ROM drive, a CD-RW drive, a DVD-ROM drive, a DVD-RW drive in communication with the device that is, e.g., attempting to access qualifying data, storing qualifying data. The drivers of such media readers/writers may perform some or all of the functionality.

The above embodiments are not mutually exclusive, since the functionality may be performed by a variety of apparatus in a variety of manners.

2. Accessing or Storing Qualifying Data

This Section 2 describes embodiments of the invention, in which it is determined whether there is an attempt by a device to access “qualifying data”. If so, one or more of several actions may be taken.

This Section 2 also describes other embodiments (not necessarily mutually exclusive with the embodiments described in the paragraph immediately above), in which it is determined whether a device stores qualifying data. If so, one or more of several actions may be taken.

2.1. Reading Data

In one embodiment, determining whether there is an attempt by a device to access qualifying data comprises (i) reading data, and (ii) determining whether the read data includes qualifying data.

In another embodiment, it is determining whether a device stores qualifying data comprises (i) reading data, and (ii) determining whether the read data includes qualifying data.

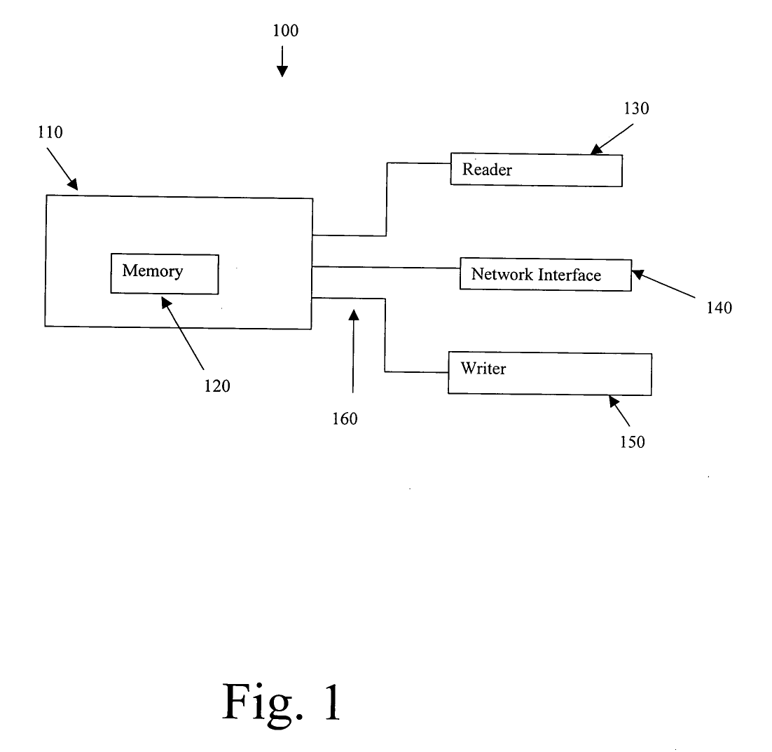

FIG. 1 illustrates an overview of an embodiment of the invention which depicts one type of such a device—a personal computer 100. The personal computer 100 includes a motherboard 110, which typically includes a microprocessor such an Intel® Pentium® microprocessor. The motherboard 110 also includes memory 120, such as RAM and/or ROM. As is known, the memory 120 is typically used to store one or more programs that are executed by the microprocessor.

The motherboard 110 may also include well known components such as BIOS, mass storage interfaces, serial and parallel ports, expansion slots, and/or controllers required to control standard peripheral devices (e.g., a display screen, a keyboard, a disk drive). Many different motherboard configurations may be used.

The motherboard 110 is in communication with known peripherals such as a reader 130, a network interface 140 and a writer 150. The reader 130 may be, e.g., a device capable of reading stored data, such as a hard drive, a CD-ROM drive, a DVD-ROM drive. The network interface 140 allows the motherboard 110 to communicate with devices across a network, such as a LAN or the Internet. The writer 150 may be, e.g., a device capable of writing data to storage, such as a hard drive, a CD-RW drive, a DVD-RW drive. Any number of peripherals may be in communication with the motherboard.

The motherboard communicates in a known manner with the peripherals via a media 160, which may include, e.g., serial cables, wireless communication frequencies, and the like.

The present invention is not limited to determining whether a personal computer stores/attempts to access qualifying data. Other appropriate devices besides personal computers include cellular telephones, other computing devices, audio players, MP3 players, personal digital assistants, handheld computer devices, handheld systems and game consoles.

Databases Defining Qualifying Data

In one embodiment, determining whether the read data includes qualifying data can comprise reading one or more databases (or like structures) that defines various types of qualifying data. For example, a database may define a plurality of database records, in which each record defines a song, video or file that is qualifying data.

Fingerprints

In general, to determine whether read data includes qualifying data, techniques employing “fingerprints” may be used in an embodiment of the invention. A fingerprint that is based on the read data may be created. The fingerprint based on the read data is compared with at least one fingerprint of a plurality of fingerprints (e.g., to determine if the read data matches any known data). Such a plurality of fingerprints may (but need not) be stored in a database (or like structure).

As is well known in the art, when a fingerprint function is applied to a set of data (e.g., a set of numbers, a file representing recorded video, a file representing audio in MP3 format) the fingerprint function defines a “fingerprint” for the set of data. A fingerprint may be, e.g., a number, a vector of arbitrary size N, a matrix of arbitrary size N×M.

As is also well known in the art, a fingerprint function ideally defines identical or similar fingerprints for sets of data that are deemed to represent the same things or similar things. For example, a fingerprint function which is designed for multimedia objects (e.g., to be perceived by humans) should result in similar fingerprints for similar objects (e.g., similar video clips of a movie).

In a fingerprint function designed specifically for objects that represent audio (and possibly other information in addition to audio), applying the function to audio objects that are perceptually similar should result in similar fingerprints. Furthermore, in order to be able discriminate between different audio objects, there should be a very high probability that dissimilar audio objects result in dissimilar fingerprints. Thus, for an ideal fingerprint function ‘F’, there should be a threshold ‘T’ such that, with very high probability:
|F(X)−F(Y)|<T
if objects X and Y are similar and
|F(X)−F(Y)|>T
if objects X and Y are dissimilar.
One document which is incorporated herein by reference is “A Highly Robust Audio Fingerprinting System”, Jaap Haitsma and Ton Kalker, International Symposium on Music Information Retrieval (ISMIR) 2002. That document is referred to herein as “Haitsma and Kalker”, and is available as of the date of filing at http://ismir2002.ismir.net/proceedings/02-FP04-2.pdf. Haitsma and Kalker describes audio fingerprinting in detail, and explains:

“Most fingerprint extraction algorithms are based on the following approach. First the audio signal is segmented into frames. For every frame a set of features is computed. Preferably the features are chosen such that they are invariant (at least to a certain degree) to signal degradations. Features that have been proposed are well known audio features such as Fourier coefficients [4], Mel Frequency Cepstral Coefficients (MFFC) [19], spectral flatness [2], sharpness [2], Linear Predictive Coding (LPC) coefficients [2] and others. Also derived quantities such as derivatives, means and variances of audio features are used. Generally the extracted features are mapped into a more compact representation by using classification algorithms, such as Hidden Markov Models [3], or quantization [5]. The compact representation of a single frame will be referred to as a sub-fingerprint. The global fingerprint procedure converts a stream of audio into a stream of subfingerprints. One sub-fingerprint usually does not contain sufficient data to identify an audio clip. The basic unit that contains sufficient data to identify an audio clip (and therefore determining the granularity) will be referred to as a fingerprint-block.

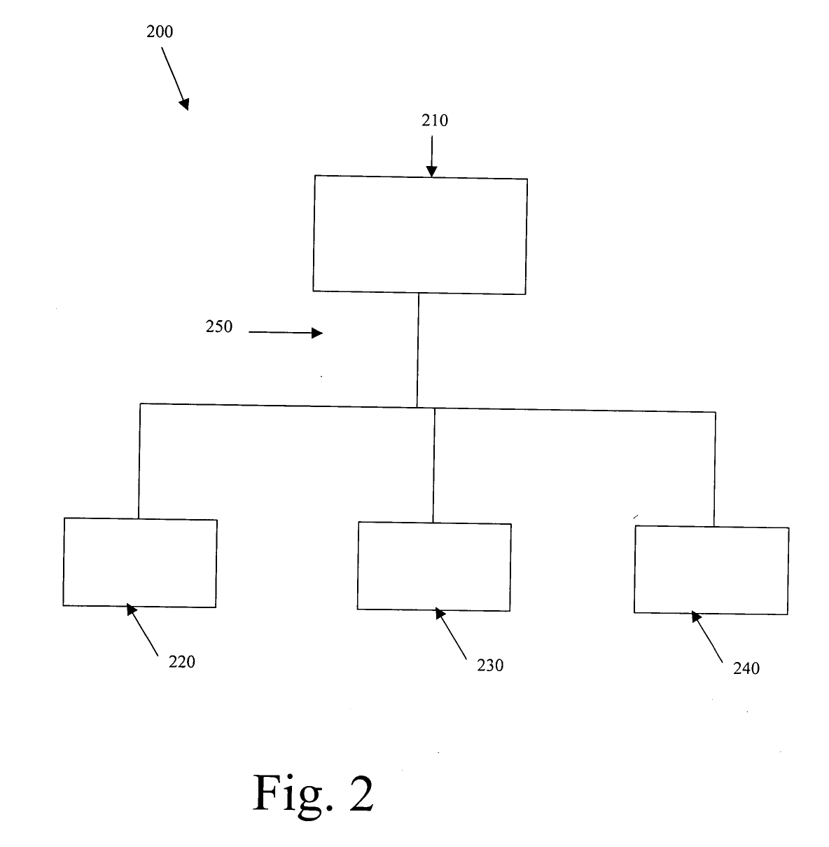

The proposed fingerprint extraction scheme is based on this general streaming approach. It extracts 32-bit sub-fingerprints for every interval of 11.6 milliseconds. A fingerprint block consists of 256 subsequent sub-fingerprints, corresponding to a granularity of only 3 seconds. An overview of the scheme is shown in FIG. 1. The audio signal is first segmented into overlapping frames. The overlapping frames have a length of 0.37 seconds and are weighted by a Hanning window with an overlap factor of 31/32. This strategy results in the extraction of one sub-fingerprint for every 11.6 milliseconds. In the worst-case scenario the frame boundaries used during identification are 5.8 milliseconds off with respect to the boundaries used in the database of pre-computed fingerprints. The large overlap assures that even in this worst-case scenario the sub-fingerprints of the audio clip to be identified are still very similar to the sub-fingerprints of the same clip in the database. Due to the large overlap subsequent sub-fingerprints have a large similarity and are slowly varying in time. FIG. 2a shows an example of an extracted fingerprint block and the slowly varying character along the time axis.

The most important perceptual audio features live in the frequency domain. Therefore a spectral representation is computed by performing a Fourier transform on every frame. Due to the sensitivity of the phase of the Fourier transform to different frame boundaries and the fact that the Human Auditory System (HAS) is relatively insensitive to phase, only the absolute value of the spectrum, i.e. the power spectral density, is retained. In order to extract a 32-bit sub-fingerprint value for every frame, 33 non-overlapping frequency bands are selected. These bands lie in the range from 300 Hz to 2000 Hz (the most relevant spectral range for the HAS) and have a logarithmic spacing. The logarithmic spacing is chosen, because it is known that the HAS operates on approximately logarithmic bands (the so-called Bark scale). Experimentally it was verified that the sign of energy differences (simultaneously along the time and frequency axes) is a property that is very robust to many kinds of processing.”

The Haitsma and Kalker document references the following documents, among others. Each of these documents is incorporated herein by reference.
[2] Allamanche E., Herre J., Hellmuth O., Bernhard Fröbach B. and Cremer M., “AudioID: Towards Content-Based Identification of Audio Material”, 100th AES Convention, Amsterdam, The Netherlands, May 2001.
[3] Neuschmied H., Mayer H. and Battle E., “Identification of Audio Titles on the Internet”, Proceedings of International Conference on Web Delivering of Music 2001, Florence, Italy, November 2001.
[4] Fragoulis D., Rousopoulos G., Panagopoulos T., Alexiou C. and Papaodysseus C., “On the Automated Recognition of Seriously Distorted Musical Recordings”, IEEE Transactions on Signal Processing, vol. 49, no. 4, p. 898-908, April 2001. Music Information Retrieval (ISMIR) 2000, Plymouth, USA, October 2000.
[5] Haitsma J., Kalker T. and Oostveen J., “Robust Audio Hashing for Content Identification, Content Based Multimedia Indexing 2001, Brescia, Italy, September 2001.
[19] Logan B., “Mel Frequency Cepstral Coefficients for Music Modeling”, Proceeding of the International Symposium on Music Information Retrieval (ISMIR) 2000, Plymouth, USA, October 2000.

Another description of an audio fingerprinting system may be found in P. J. O. Doets, R. L. Lagendijk, “Theoretical Modeling Of A Robust Audio Fingerprinting System”, Proceedings of the Fourth IEEE Benelux Signal Processing Symposium, pp. 101-104, 2004. This document is incorporated herein by reference.

In an embodiment where it is desirable to determine, among other things, the presence of certain kinds of audio data (e.g., MP3 files of copyrighted songs), then a desirable fingerprint function may determine perceptual audio features of the audio data.

In such an embodiment, creating a fingerprint that is based on the read data can comprise creating a fingerprint that is based on perceptual audio features of a plurality of “frames”. Each such frame represents a portion of the duration of the read data (e.g., 11.6 milliseconds of read data). Haitsma and Kalker describe an embodiment of this process in great detail.

Alternatively or additionally, creating a fingerprint that is based on the read data can comprise (i) segmenting the read data into a plurality of frames, (ii) for each of the frames, computing a set of features, and (iii) mapping each set of features to a sub-fingerprint. Haitsma and Kalker describe an embodiment of this process in great detail.

In particular, Haitsma and Kalker describe an embodiment in which each frame represents 11.6 milliseconds of read data, thereby rendering 256 sequential sub-fingerprints for a representation of about 3 seconds of read data.

As described above, the fingerprint which is based on the read data may be compared with at least one fingerprint of a plurality of fingerprints. The plurality of fingerprints may be stored in a local or non-local database (or like structure). The plurality of fingerprints may be stored in a simple “table” structure that is well known in the art. The table may merely be an enumerated collection of such fingerprints (e.g., each of the plurality of fingerprints stored in 8192 consecutive bytes). Each fingerprint may optionally be associated with further information (e.g., name or the work, author, genre, artist, title, album, date created, date released, production company, publisher, distributor, copyright information, purchasing information) as desired. For example, each fingerprint may comprise the first, e.g., 8192 bytes in a row of a table structure, and the remaining, e.g., 1024 bytes of the row, denote further information about the data the fingerprint represents. Such tables and like structures can be sorted or indexed, if desired, in a number of ways that are well known to one of ordinary skill in the art. Such tables and like structures can be read, searched and otherwise processed in manners that are well known to one of ordinary skill in the art.

In one embodiment, determining whether the read data includes qualifying data can comprise reading across a network to a database of fingerprints (or other stored plurality of fingerprints). For example, a database may be stored on one or more servers which are accessible over the Internet in a known manner. Such a database can be queried in a known manner to determine (i) if a particular fingerprint exists in the database, and/or (ii) further information associated with the fingerprint.

FIG. 2 illustrates a network 200 of an embodiment of the invention. The network includes a computing device 210 which may be a server or other device capable of communicating with (and optionally providing resources to) a plurality of computing devices 220, 230 and 240 via a medium 250 in a known manner. Any number of computing devices may be in communication with the computing device 210.

The computing devices 220, 230 and 240 may be, e.g., personal computers, cellular telephones, or other devices which, e.g., may store or attempt to access qualifying data.

The computing device 210 may include a plurality of devices which cooperate to provide a database (or like structure) of fingerprints. Such a plurality of devices may store redundant copies of the database and/or may store portions of the database.

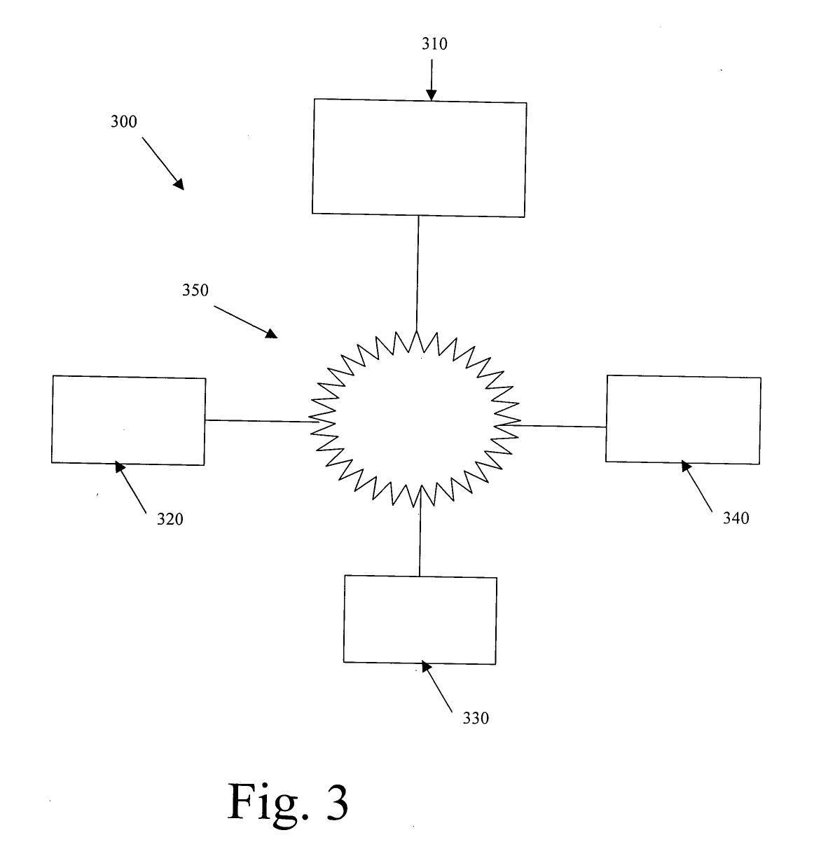

FIG. 3 illustrates a network 300 of an embodiment of the invention. In the network 300 a plurality of computing devices 310, 320, 330 and 340 communicate with each other via a medium 350 without requiring a central authority such as a server. Any number of computing devices may communicate with each other in such a manner.

The computing devices 310, 320, 330 and 340 may cooperate to provide a database (or like structure) of fingerprints. The computing devices 310, 320, 330 and 340 may store redundant copies of the database and/or may store portions of the database.

In one embodiment, determining whether the read data includes qualifying data can comprise reading a local database of fingerprints (or other locally-stored plurality of fingerprints). Such a local database of fingerprints may be, e.g., stored on a hard drive (or other storage medium such as flash memory, CD, DVD) of a personal computer (or other device) that, among other things, determines whether the read data includes qualifying data. As is known in the art, such a storage medium may accessible to the computer through, e.g., a USB 2.0 connection, an Integrated Drive Electronics (“IDE”) connection. Ideally, the locally-stored plurality of fingerprints is accessible to the personal computer (or other device) even if the personal computer/device lacks Internet access or a LAN connection.

A locally-stored plurality of fingerprints can be advantageous. Locally-stored data are typically quicker to access and easier to access. In addition, locally-stored data typically remain accessible even if, e.g., certain types of network access (e.g., Internet access) are impaired, unreliable or inoperative.

In one embodiment, the locally-stored plurality of fingerprints is capable of being updated. For example, software may direct the database to be updated by (i) receiving additional fingerprints from across a network, (ii) receiving data indicating changes to make to the locally-stored plurality of fingerprints (e.g., what to delete), and/or (iii) a set of fingerprints intended to represent the entirety of the locally-stored plurality of fingerprints.

Such updates can occur, For example, (i) periodically, (ii) when requested by the entity storing the locally-stored plurality of fingerprints, (iii) when requested by another entity (e.g., a server in control of fingerprints) and/or (iv) in response to certain events (e.g., a database of fingerprints is suspected of being corrupted or otherwise inaccurate).

In addition to or instead of using fingerprints to determine whether the read data includes qualifying data, other techniques may be employed, alone or in various combinations. There are many reasons to select various techniques. For example, a technique which can be slow and/or resource intensive may mandate that, on a particular platform, its use is curtailed or used in combination with other techniques (e.g., techniques which do not share those drawbacks). Thus, various combinations of techniques can be employed as desired to efficiently make use of time and resources.

In particular, some fingerprinting algorithms (depending on such things as bits per fingerprint, particular fingerprint function used, and the size of the fingerprint database) can be relatively slow compared to other techniques for determining whether the read data includes qualifying data. It may be that, in a selected combination of techniques, no single technique provides a definitive answer regarding whether the read data includes qualifying data. However, the combination of techniques can indicate, e.g., an acceptably high probability that the read data includes qualifying data.

For example, another technique used in determining whether the read data includes qualifying data is to compare the read data (or parts thereof) to determine the presence of predetermined data (e.g., predetermined sequences of bits).

For example, another technique used in determining whether the read data includes qualifying data is to determine whether the read data represents a multimedia file. This is advantageous where qualifying data is defined as, among other things, certain types of multimedia (e.g., songs). One manner of determining whether the read data represents a multimedia file (if the read data is in one or more files) or multimedia stream (if the read data is in one or more streams) is to determine whether the file extension of the read data indicates a multimedia file. For example, many file extensions (e.g., .avi, .rm, .mov, .mpg) denote video files. Similarly, many file extensions (e.g., .mp3, .wav, .wma) denote audio files.

Other file extensions denote a file that has been altered in a manner in which the original can be recovered. For example, the file extension .zip denotes a file which has been compressed, in a manner such that the original (uncompressed and typically larger) file may be recovered in a known manner. File extensions denoting compression may be useful in indicating, e.g., an attempt to obfuscate a file representing qualifying data.

As used in this application, the term “represent” is not exclusive. For example, “data representing multimedia” can include data representing multimedia as well as something else. Thus, for example, “data representing music” does not mean “data representing only music”.

Additionally or alternatively, another technique used in determining whether the read data includes qualifying data is to determine whether the read data includes digital rights management (DRM). This is advantageous where qualifying data is intended to be protected from, e.g., unauthorized copying. A file that includes DRM is unlikely to have been acquired in violation of copyright.

Additionally or alternatively, another technique used in determining whether the read data includes qualifying data is to determine whether the read data corresponds to a copyrighted work. For example, it may be determined that read data corresponds to a copyrighted work if, e.g., a fingerprint of the data corresponds to a fingerprint in database of copyrighted works.

Additionally or alternatively, another technique used in determining whether the read data includes qualifying data is to determine if the read data includes certain information which identifies the data (e.g., a music file) as legitimate. Such information may include a digital “receipt” included in the read data, or an index to a database which links, e.g., a unique music title with its trademark and owner.

As an example of using the above techniques in combination, in one embodiment determining whether the read data includes qualifying data includes determining that (i) the read data represents a multimedia file, (ii) the read data corresponds to a copyrighted work, and also (iii) the multimedia file does not include digital rights management.

As an example of using the above techniques in combination, in one embodiment determining whether the read data includes qualifying data includes determining that (i) the read data includes a particular file name (e.g., any of a predetermined plurality of names), (ii) the read data has a certain file size (e.g., a file size within 50 bytes of a certain number of bytes), and (iii) the read data is a certain file type or includes a certain file extension (e.g., is type MP3, include either .MP3 or .WMA).

With further reference to this particular example, there can be a database, table or like structure that includes a plurality of entries, each of which is indexed, e.g., by file name. Each entry in the database defines, for each file name, a range of file sizes and one or more file types. Thus, each entry defines whether read data is qualifying data (i.e. if the read data corresponds to the file name, file size and file type/extension of any entry). Such entries may also include data representing a fingerprint.

In one embodiment, a database or like structure defines a set of appropriate (authorized) data. For example, a table may store a list of music. Any read data that did not correspond to an entry in the database (e.g., unrecognized music) would be deemed “illegal” or unauthorized and appropriate action might be taken (e.g., warn, delete, alter, render inaccessible and/or provide an offer).

Additionally or alternatively, another technique used in determining whether the read data includes qualifying data is to determine a source of the read data. The source may be, e.g., a particular process or program (e.g., the Kazaa® program) that receives the data, a particular process or program that requested the data, a particular port over which the data was received, a particular IP address from which the data was received, a particular URL (“Uniform Resource Locator”) from which the data was received, a particular MAC address from which the data was received.

It can advantageous to determine a source of read data where, e.g., certain sources indicate a higher (or lower) probability that the data is qualifying data. For example, files copied via a (or a particular) peer-to-peer file sharing program may indicate a higher probability that, e.g., the data is copyrighted and being copied without compensation. Accordingly, determining a source of the read data may include comparing the source to a set of predetermined sources (e.g., a set of peer-to-peer file sharing program, URLs which are known or believed to provide unauthorized copies of software).

One source is of data is known as a BitTorrent network. As is known in the art, BitTorrent is generally a peer-to-peer protocol for distributing files. The protocol uses the upstream bandwidth of downloading devices in a manner which increases the effectiveness of the distribution as a whole. On average, the faster a device uploads to its peers, the faster the device will be able to download. A BitTorrent network generally performs better than conventional peer-to-peer network when there exist many end users for a single file.

A BitTorrent file distribution system typically includes (i) an ‘original’ downloader, (ii) end user downloaders, (iii) end user web browsers, (iv) a web server, (v) a BitTorrent tracker, and (vi) a static ‘metainfo’ file.

In “serving”, a host typically performs the following steps:
1. Start running a tracker (or have one running already)
2. Start running a web server, such as Apache (or have one running already)
3. Associate the extension .torrent with mimetype application/x-bittorrent on the web server (or have done so already)
4. Generate a metainfo (.torrent) file using the complete file to be served and the URL of the tracker
5. Put the metainfo file on the web server
6. Link to the metainfo (.torrent) file from some other web page
7. Start a downloader which already has the complete file (the ‘origin’)

In downloading, a user typically performs the following steps:
1. Install BitTorrent client program (or have done so already).
2. Access the World Wide Web p1 3. Click on a link to a .torrent file
4. Select where to save the file locally/select a partial download to resume
5. Wait for the download to complete
6. Tell downloader to exit (it keeps uploading until this happens).

The connectivity is typically:
The web site serves up static files as normal, but kicks off the BitTorrent helper application on the clients.
The tracker receives information from all downloaders, and give them random lists of peers. This may be done done over HTTP or HTTPS.
Downloaders periodically check in with the tracker to keep it informed of their progress. Downloaders upload to and download from each other via direct connections. These connections use the BitTorrent peer protocol, which operates over TCP.
The origin uploads but does not download, since it has the entire file. The origin gets the entire file into the network. For popular downloads, the origin can be taken down after a while (since several downloads may have completed and been left running indefinitely).

Other types of file distribution protocols may be readily employed as well.

2.2. Search Parameters

In one embodiment, determining whether there is an attempt by a device to access qualifying data comprises (i) determining at least one parameter of a search for data, and (ii) determining whether the at least one parameter indicates a particular kind of qualifying data.

In another embodiment, it is determining whether a device stores qualifying data comprises (i) determining at least one parameter of a search for data, and (ii) determining whether the at least one parameter indicates a particular kind of qualifying data.

In one embodiment, determining at least one parameter of a search can comprises determining at least one parameter of a search for data that is not stored locally.

The data that is not stored locally may be, e.g., a file which the user desires to find via a file-sharing network. The data that is not stored locally may be, e.g., data which the user desires to find via an Internet search engine, such as Google.com.

The search parameters may be in one or more of many forms. For example, in a typical program which accesses peer-to-peer file-sharing network, acceptable parameters include file name, file size, type of file (e.g., audio, multimedia, text), artist. In a typical Internet search engine, acceptable parameters include keywords in a web page, language, date of last update, file format, domain of the web page.

Such data that is not stored locally is not (yet) stored on, e.g., a hard drive (or other storage medium such as flash memory, CD, DVD) of a personal computer (or other device) that, among other things, the user employs to execute the search.

A search result may be received in response to the executed search. For example, a list of files (or other data corresponding to the search result) matching one or more search parameters may be returned (e.g., received by the web browser, received by a peer-to-peer file sharing program). The user may desire to receive one or more of such returned files. If so, the user can, in a known manner, transmit a request to receive data corresponding to the desired search result. Typically, this initiates a download of the desired file in a known manner, and data corresponding to the search result is received.

To determine at least one parameter of a search for data that is not locally stored, software executing on the personal computer may, e.g., determine at least one key word that is transmitted to a search engine via a web browser, determining at least one parameter (e.g., keyword) of a search query directed to a file-sharing network.

Since the search parameters may be executed by such software as a web browser or software for accessing a file sharing network, it can be advantageous for software to be capable of determining, e.g., what key words a browser transmitted, what search parameters a file haring program transmitted. Such a determination may be made in a variety of manners well within the skill of the ordinary artisan. For example, data which is transmitted by a particular process (e.g., a process corresponding to the Kazaa® application) may be intercepted and parsed to determine its contents.

Hooking API Functions

Alternatively or additionally, software may establish an application-specific or system-wide “API interceptor” function. Such an API interceptor is a function that effectively “monitors” calls made to particular application or system functions (e.g., a function which transmits a search query, a function which transmits data via winsocket to a remote server). Many techniques for intercepting a function call (also known as “hooking an API function”) are known in the art.

In general, when a process or application issues a call to such a monitored function, the API interceptor gains control and performs processing as desired (e.g., executes another function, executes another function before the monitored function, execute another function after the monitored function). In other words, an API interceptor redirects API calls made by other applications/processes to another function, rather than the function indicated by the called API.

For example, one technique known in the art for hooking an API is to “patch” the API, typically by inserting, at the beginning of the monitored API function, an instruction which transfers control (e.g., a JMP or CALL instruction). If desired, the first few bytes of the function can first be saved to a pre-allocated buffer in memory (a “stub”). Saving the bytes allows the new function (to which control is transferred) to restore the intercepted function to its previous (unhooked) state. The exact number of bytes to be copied to the stub may depend on the instructions present at the beginning of the function.

Detailed description of interception techniques may be found at “Detours: Binary Interception of Win32 Functions”, Galen Hunt and Doug Brubacher, Proceedings of the 3rd USENIX Windows NT Symposium. Seattle, Wash., July 1999, pages 135-143, which is incorporated herein by reference. This document generally describes instrumenting and extending existing operating system and application functionality. Specifically, it describes a library for instrumenting arbitrary Windows® Win32 functions on Intel® x 86 machines.

2.3. Attempting to Store Data

In one embodiment, determining whether there is an attempt by a device to access qualifying data comprises determining whether there is an attempt by a device to store the qualifying data. Similarly, in one embodiment, determining whether there is an attempt by a device to access qualifying data comprises determining whether a device has stored the qualifying data.

It can be desirable to consider a variety of types of “storing” and/or “attempting to store”. For example, a device may store/attempt to store the qualifying data to a peripheral such as a hard drive, a removable media recorder, and/or a random access memory. Such peripherals may be connected to, e.g., a personal computer that executes software making a determination as to whether there was a storing or an attempting to store. In one embodiment, storing/attempting to store the qualifying data may include transmitting/attempting to transmit the qualifying data to a peripheral device (e.g., of a computer).

In one embodiment, determining whether a device stores/attempts to store qualifying data comprises determining whether a file has been added. For example, it can be determined (i) whether a file has been added to a particular storage medium (e.g., to a hard disk drive but not to a CD-RW drive), and/or (ii) whether a file has been added to any medium (e.g., to any peripheral capable of storing files).

Determining whether a device stores/attempts to store the qualifying data may include determining whether the device accesses/attempts to access one or more predetermined functions of an operating system running on the device. Such predetermined functions can include a function that is executed for every (or substantially every) write command to a storage medium.

For example, in one embodiment the Microsoft Windows XP® system function that is executed when a write command can be “hooked” (e.g., as described above) on a personal computer running the Windows XP® operating system. Calls made to this system function from any application or process can be intercepted and redirected (temporarily) to a function which, e.g., sets a flag or otherwise indicates that an attempt has been made to write data (e.g., to a storage medium, to a certain folder on a storage medium). That data can be read to determine, e.g., whether it includes qualifying data (as has been described above).

In another embodiment, alternatively or additionally, an operating system function may be used to monitor or watch certain activity, such as writing or an attempting to write to a storage medium (e.g., writing to a hard drive, writing to a predetermined folder on the hard drive, writing to a predetermined sector on a CD).

Thus, the device on which the operating system runs can be used to determine whether a file has been added. For example, it may be determined (i) whether a file has been added to a particular storage medium (e.g., to a hard disk drive but not to a CD-RW drive), and/or (ii) whether a file has been added to any medium (e.g., to any peripheral capable of storing files).

In the Microsoft® Windows® operating system, the function “ReadDirectoryChangesW” of the Win32 API retrieves information that describes changes within a directory (either anywhere within one or more folders and all subfolders thereof, or only anywhere within one or more folders). Generally, the “ReadDirectoryChangesW” function can be used to monitor a directory (e.g., a folder in a file hierarchy) and alerts the caller (a calling function) when certain events occur.

The function “ReadDirectoryChangesW” can operate using a filter “FILE_NOTIFY_CHANGE_FILE_NAME”. When using this filter, a change to file names (which includes renaming, creating, or deleting a file) in the monitored directory or subtree causes the “ReadDirectoryChangesW” function to return a change notification wait operation.

In particular, the “ReadDirectoryChangesW” function returns (in a buffer that is the function's second parameter) an “action”. If the value of that action is “FILE_ACTION_ADDED”, this denotes that a file was added to the monitored directory.

The function “ReadDirectoryChangesW” may be called from a thread which calls the function, essentially awaiting the prescribed activity (e.g., of a file being added to the monitored directory). The sample instructiosn below, written in the “C” programming language, illustrate a use of the function “ReadDirectoryChangesW”:

CCriticalSection toLock;
CListCtrl* pList;
CListCtrl* pList1;
HANDLE hDir = CreateFile( CString(“c:\\Program Files”),//
file name pointer

| | |
|---|---|
| FILE_LIST_DIRECTORY, | // access mode |
| (read/write) | |
| FILE_SHARE_READ\|FILE_SHARE_DELETE, | // share mode |
| NULL, | // security |
| descriptor | |
| OPEN_EXISTING, | // mode of |
| | creation |
| FILE_FLAG_BACKUP_SEMANTICS, | // file attributes |
| NULL | // file with |
| attributes to copy | |
| ); | |

FILE_NOTIFY_INFORMATION Buffer[1024];
DWORD BytesReturned;
while( ReadDirectoryChangesW (

| | |
|---|---|
| hDir, | // handle to |
| directory | |
| &Buffer, | // read results |
| buffer | |
| sizeof(Buffer), | // length of |
| buffer | |
| TRUE, | // monitoring |
| option | |
| FILE_NOTIFY_CHANGE_FILE_NAME, | // filter |
| &BytesReturned, | // bytes returned |
| NULL, | // overlapped |
| buffer | |
| NULL | // completion |
| routine | |

```
    ))
    {
    CTime tm = CTime::GetCurrentTime( );
    CString helper_txt;
    switch(Buffer[0].Action)
      {
      case FILE_ACTION_ADDED:
        helper_txt = “file was added to the
directory”;
        break;
      case FILE_ACTION_REMOVED:
        helper_txt = “file was removed from the
directory”;
        break;
      case FILE_ACTION_MODIFIED:
        helper_txt = “ file was modified”;
        break;
      case FILE_ACTION_RENAMED_OLD_NAME:
        helper_txt = “file was renamed - old name”;
        break;
      case FILE_ACTION_RENAMED_NEW_NAME:
        helper_txt = “The file was renamed - new
name”;
        break;
      } // switch
    int bufferIndex = 0;
    do
      {
      toLock.Lock( );
      int item = pList1->InsertItem(pList1-
>GetItemCount( ),
CString(Buffer[bufferIndex].FileName) .Left(Buffer[bufferIndex].
FileNameLength / 2) + “ - ” + helper_txt );
      pList1->SetItemText(item, 1, tm.Format(“%Y/%m/%d/
- %H:%M:%S”));
      bufferIndex ++;
      toLock.Unlock( );
      } // do
    while (!Buffer[bufferIndex].NextEntryOffset);
} // while ReadDirectoryChangesW
```

In another embodiment, determining whether a file has been added comprises determining files that exist (e.g., in a certain directory, on an entire storage medium, on a plurality of storage mediums) at one time, and determining what files exist at another time. Differences between the two can, in a straightforward manner, indicate the creation of a file, the modification of a file, the relocation of a file and/or the deletion of a file.

One of ordinary skill in the art will easily recognize and understand many possible variations to the above description of storing/attempting to store data.

As described above, it can be particularly advantageous to determine whether a file has been added to a particular folder. For example, a particular folder (e.g., C://Program Files/Kazaa/Shared) or plurality of folders (e.g., C://Program Files/Kazaa/Uploads and C://Program Files/Kazaa/Downloads) may be used by particular programs (e.g., Kazaa® program for accessing a peer-to-peer file sharing network) to store data (e.g., all files copied to the device, all files made available to transmit from the device to requesting devices via the Internet). Such folders may be known a priori (e.g., regardless of the particular device running the program) or may be determined (e.g., by determining, from the settings the program, which folder(s) are the desired folders). Thus, monitoring a particular folder or folder(s) can be advantageous in situation which, e.g., involve programs that commonly are used to create files on a device (e.g., a program for accessing a peer-to-peer file sharing network, a program for accessing a bitTorrent network, a program which searches the Internet for certain content).

It can be determined whether a device stores qualifying data. For example, when certain software implementing the functionality of an embodiment of the invention is first installed, e.g., on a personal computer, the software may scan a hard drive for the presence of qualifying data. Such software may otherwise determine whether a persistent storage peripheral device of the device (e.g., an external drive) stores qualifying data.

A file directory which describes a plurality of files stored on a hard drive of the device can be read in a known manner. Form this directory, it can be determined whether any of the plurality of files includes qualifying data. Such a determination may be made in a number of manners, such as by (i) reading each of the plurality of stored files, and (ii) determining, for each of the read files, whether the read file includes qualifying data (as described herein).

Not all such files need be evaluated in this manner. It might be desirable to determine whether any subset of the plurality of files (or any at all) includes qualifying data. For example, a warning can be issued upon finding a single instance of qualifying content.

It may similarly be desirable to merely determine whether any of the plurality of files represents, e.g., a multimedia file, a multimedia file without DRM. For example, a warning can be issued that unauthorized transmitting or receiving of multimedia files is prohibited.

Generally, whether the read data includes qualifying data can comprise comparing the read data to one or more types of information in one or more databases (e.g., comparing the read data to various fingerprints, file names, song names, etc.)

Thus, various information defines what is qualifying data. The definition of what is qualifying data may be received from one or more parties, such as an author, publisher, distributor, or manager who desires to monitor for attempts to access specific data (e.g., data defining the particular songs of the artists, the particular music of the publisher). Such parties may also desire to direct users who attempt to access that particular qualifying data (e.g., the publisher's songs) to a particular fulfillment node (e.g., a web site owned by the publisher which allows the content to be acquired legally). Accordingly, such databases defining, e.g., a music file, may define a corresponding web site (e.g., where that music can be purchased).

Such parties may be required to pay for allowing the content they specify to be recognized and/or used in triggering various actions (e.g., directing to a web site for purchase). Such parties may pay per file they specify, per referral, etc.

Similarly, various parties may define fulfillment nodes (e.g., merchants, retailers, publishers, authors which can provide songs for sale or otherwise). Such parties may provide information that allows certain users who access qualifying data to be directed to the fulfillment nodes (e.g., to purchase copies of songs desired to be downloaded). Such parties may provide, e.g., URLs (defining their web sites where music can be purchased). Such parties may provide, e.g., URLs and corresponding files (defining specific web pages for each of a plurality of songs that can be purchased). Such parties may provide information defining certain files (defining specific songs that can be purchased via their web site).

Such parties may be required to pay for referrals to them, possibly based on the number of referrals to them.

3. Providing an Offer to Purchase

Section 2 above generally describes embodiments in which it is determined that a device has stored or attempted to access “qualifying data”.

This Section 3 describes a type of action that may be taken if there is an attempt by a device to access or store qualifying data. Specifically, if it is determined that a device has stored or attempted to access “qualifying data”, then an offer to purchase an item may be provided. It is particularly advantageous to provide an offer to purchase an item that corresponds to the qualifying data. For example, if the qualifying data represents a particular work of authorship (e.g., a song), then the offer can be an offer to purchase that work of authorship (e.g., by legally purchasing a new file of the song, by purchasing a license to the file already downloaded).

As used herein, the term “item” includes a good (e.g., a music file), a service and/or a right (e.g., a license to receive a copy of a copyrighted work of authorship for personal use).

In one embodiment, a work of music corresponding to the qualifying data is determined. For example, a fingerprint of the read data may correspond to a fingerprint (e.g., stored in a fingerprint table) associated with a particular song. Alternatively, the read data may include information (e.g., in a ID3 tag on an MP3 file) that indicates characteristics (song title, artist) from which the work of authorship may be identified.

It can also be advantageous to provide an offer to purchase an item that is related to the qualifying data. For example, if the qualifying data represents a movie or a portion of a movie, the offer can be for the soundtrack of that movie (e.g., as an audio file to be downloaded, as a CD which will be shipped). If the qualifying data represents a song by a particular artist, other songs by that artist may be offered.

Various systems for receiving a response to the offer are possible. For example, a component (e.g., button, hyperlink) of a graphical user interface may be provided. The component, when clicked, can represent acceptance of the offer. Many other methods of receiving user input are well known.

4. Facilitating a Purchase

If an acceptance of the offer is received, the purchase of the item may be facilitated in a number of manners described herein.

However, even in embodiments where there is no offer, the purchase of the item may be facilitated. For example, if it is determined that a device has stored or attempted to access “qualifying data”, then the purchase of an item (that is not offered) may be facilitated. Such an item may still be determined as described above with respect to the offering of items based on qualifying data. For example, if a user downloads a particular song, the purchase of that song may be facilitated (even if there is no offer).

Facilitating the purchase of the item may include referring the device to a predetermined web site or to a browser-readable document located elsewhere. The web site may allow one or more items to be purchased, e.g., through various combinations of clicking and other well-known interactions with, e.g., a web browser. Web browsers are commonly used to access web pages both on the World Wide Web and web pages elsewhere. The web site may include, e.g., a web page on a remote server, a web page that is accessible to public, a web page that is accessible to only portion of the public, a web page that is stored locally (such as on the device), a web page hosted by a network access provider.

In one embodiment, the device is referred to a web site from which item may be purchased. For example, the device may be referred to a merchant that sells the music (e.g., http://musicdownloads.walmart.com).

In one embodiment, referring the device to the web site may include displaying a message (e.g., “Purchase this music at Walmart®”).

In one embodiment, referring the device to the web site may include redirecting a browser to a predetermined URL.

In one embodiment, referring the device to the web site may include providing a hyperlink that, when clicked on, directs a browser to a predetermined URL.

Although many of the above embodiments generally describe or refer to purchasing an item, in various other embodiments a purchase need not be involved.

For example, rather than a purchase of an item, a media file could be played (or another type of file could be opened). In such an embodiment, a media file (which might have been offered to be purchased in above-described embodiments) may be offered to be played (e.g., by a media player resident on a personal computer). In such an embodiment, the media file may comprise a “free sample” of a media file which a user has, e.g., attempted to download or copy. If such an offer is accepted, a media player (e.g., Microsoft's Windows Media Player [symbol] Real Network's RealPlayer [symbol] could be executed, and/or directed to play a predetermined media file or a random media file. If necessary, the media file to play could be automatically acquired (e.g., downloaded from the Internet, retrieved from storage).

The media file to play can be “streamed” from a streaming source (e.g., a server accessible via the Internet). Such an embodiment could be advantageous where it is desirable to make it difficult for users to obtain a re-usable copy of a media file.

The media file to stream could be part of service which streams media or other data. For example, Pressplay [symbol] (http://www.pressplay.com) and Rhapsody (http://www.listen.com) offer streaming audio to users. Rhapsody users, for example, pay a monthly fee (e.g., $9.95) for unlimited streaming selections from a 350,000-track library, and those users can copy songs to media (e.g., CDs) for a fee (e.g., 79 cents per song copied).

Such a service could be provided for free or for payment of, e.g., a subscription fee, a reduced subscription fee. Such a service could also be provided temporarily (e.g., one day) as part of a trial.

In such an embodiment, the accessing of (or attempting to access) qualifying content by a user could provide the user with a trial (or offer for a trial) for such streaming media service. Thus, the attempt accessing of qualifying content can serve to promote one or more streaming media services.

Thus, in general, embodiments referencing a purchase of an item can be freely substituted with embodiments referencing the playing of an item (e.g., a media file) and/or the trial of a service (e.g., a streaming media service).

5. Recording Data

It may be advantageous to record various types of information involving any of the embodiments of the invention.

For example, it can be advantageous to record data that indicates (i) the number of redirects or referrals, (ii) the destinations of the redirects or referrals, (iii) which offers were accepted, (iv) how many offers were accepted, (v) which qualifying data the device attempted to access, (vi) which qualifying data the device stored.

6. Other Responses

Instead of (or in addition to) offering an item, if it is determined that a device stores/attempts to access qualifying data, one or more other actions may be taken.

According to one embodiment, dissemination of the qualifying data can be hindered or prevented (e.g., moving the qualifying data from a ‘shared’ folder, deleting the qualifying data).

According to one embodiment, DRM can be applied to the qualifying data.

According to one embodiment, the qualifying data can be ‘quarantined’ (rendered visible but unusable, placed in a predetermined folder in a file structure).

According to one embodiment, the qualifying data can be rendered inaccessible by being altered, deleted, scrambled.

According to one embodiment, information may be provided about the qualifying data (e.g., what was done to the qualifying data, how to obtain a legal copy of the data)

7. Assuring Unimpeded Functionality

It can be desirable to prevent/impede/reduce the desirability of disabling the functionality of various embodiments described above. For example, functionality could be disabled by, e.g., uninstalling the software, disabling or alter the software, preventing the software from executing, preventing the software from executing properly.

Embodiments of the invention assure that the software (or other means) performing certain functionality continues to function unimpeded (e.g., continues to provide appropriate offers at advantageous times). For example, a network access provider (e.g., an Internet service provider, a network administrator of a LAN or WAN) can require that the software continues to execute unimpeded.

The network access provider may periodically monitor the personal computer for the presence and health of that software. If the network access provider determines, e.g., that the software is not executing and/or has been altered, the network access provider can deny network resources to the personal computer (e.g., deny Internet access to the personal computer).

Assuring unimpeded functionality may be accomplished in many ways. For example, if functionality is determined to be impeded, one or more of the following actions can be taken:
denying some benefit (e.g., network resources) to the device
reinstalling the software
warning
notifying (e.g., a system administrator) of the impediment

Additionally or alternatively, a benefit can be provided if the functionality is not determined to be impeded.

In one embodiment, the software is periodically reinstalled, whether or not the functionality determined to be impeded

8. Peripheral

As described above, in embodiments of the invention various functionality described herein may be performed by software. In other embodiments the functionality ay be performed by hardware or a combination of hardware and software.

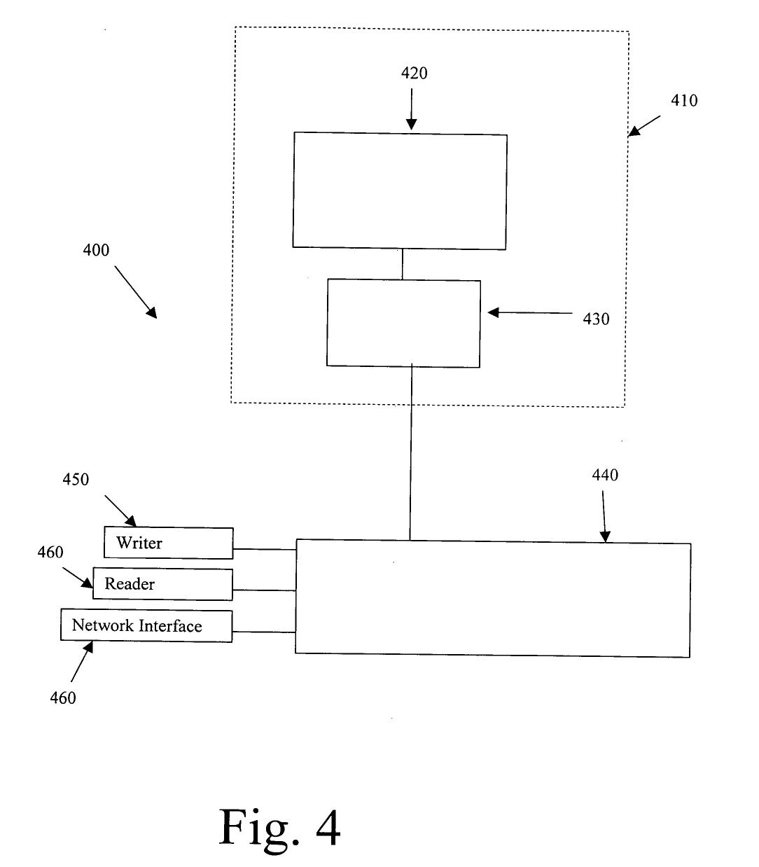

FIG. 4 illustrates an overview of an embodiment 400 of the invention in which a peripheral device 410 comprises a combination of (i) a conventional peripheral 420 (e.g., a hard drive, a CD-ROM drive, an MP3 player, a flash memory device), and (ii) a device 430 which is in communication with both the conventional peripheral 420 and a motherboard 440.

The device 430 may be capable of one or more of the following: (i) receiving some or all data sent between the conventional peripheral 420 and the motherboard 440, (ii) changing the data sent between the conventional peripheral 420 and the motherboard 440, (iii) making determinations based on some or all communication between the conventional peripheral 420 and the motherboard 440, (iv) sending commands to the conventional peripheral 420 and/or the motherboard 440.

The device 430 may, for example, (a) receive from the motherboard 440 a read request destined for the conventional peripheral 420, (b) receive from the conventional peripheral 420 a set of data destined for the motherboard 440, (c) determine that the set of data includes qualifying data, (d) in response, instruct the motherboard to execute a referral process (e.g., display in a browser a predetermined web page).

The device 430 may be integrated with the conventional peripheral 420 (e.g., the conventional peripheral 420 and the device 430 are housed in a single unit).

The device 430 may be integrated with a port on the motherboard which connects to the conventional peripheral 420 (e.g., the device 430 is a portion of a USB port on the motherboard).

The invention has been described in this application with respect to different embodiments. Persons of ordinary skill in the art will understand that various modifications may be made without departing from the spirit and scope of the invention. For example, a description of a process does not imply that the steps of the process must proceed in the order presented, and does not imply that all steps of the process are required in all embodiments of the invention. As used in this application, absent an explicit statement to the contrary, the terms ‘comprise’, ‘include’ and the like are intended to mean ‘include but are not limited to’, and the terms ‘a’, ‘an’, ‘the’ and the like are intended to mean ‘one or more’.

9. Further Embodiments

Immediately below are further embodiments. These embodiments are not mutually exclusive with the other embodiments described herein.

Some or all monitoring functions (e.g., determining whether there is an attempt by a device to access qualifying data) may be performed by one or more components of a ‘trust system’. One example of a trust system is described in detail in the section below entitled “A Trust System”. An “Agent” of such a trust system may perform some or all of the monitoring functions described in this document. Various modifications of this example will be apparent, and various other types of trust systems will also be apparent.

Some or all monitoring functions described herein may be performed by one or more components of a download assistant. For example, one example of a download assistant is described in detail in the section below entitled “A Download Assistant”. Client-side software of such a download assistant may perform some or all of the monitoring functions described in this document. Various modifications of this example will be apparent, and various other types of trust systems will also be apparent.

A download assistant can be deliberately download and run by a user of a computer, and may do so, e.g. because the download assistant provides desirable functionality and/or because the user is compensated for doing so (e.g. the user gets a paid, receives a promotional code).

Some or all monitoring functions may be performed by client side software, which includes a worm, a virus and the like.

Some or all monitoring functions may be performed by a server that communicates with the computer to determine the activities of the computer.

Client-side software can be launched with or without user intervention. Client-side software can also run in the background or the foreground.

9.1 Collecting Information

Embodiments of the invention permit the collection of data regarding demand for downloads, including peer-to-peer downloads. Such collected data may be aggregated (e.g., from a plurality of computers on a network), stored (e.g., in a database), analyzed (e.g., sorting, running a database query), extracted, presented and output (e.g., displayed on a screen, printed by a printed, transmitted to another computer, stored in another database) in well-known manners.

For example, a device can receive, from each of a plurality of computers, data about at least one copy made to the respective computer. A copy may include a copy (creation) of a file made to the hard drive or other storage medium of a computer.

Such a device could receive (e.g., from software running on each of a plurality of computers) data about at least one download of, e.g., a music file, to the respective computer via a peer-to-peer network.

In another embodiment, a network device (e.g. a Gate of a trust system) could receive, from software (e.g. an Agent of a trust system) running on each of a plurality of computers served by the network device, data about at least one download of a music file to the respective computer(s).

In another embodiment, a device can receive, from each of a plurality of network devices (e.g. Gates of a trust system), data about downloads to computers served by the respective network devices. For example, if each Gate serves a network at a different school, then various data can be collected about activities (individually and/or in the aggregate) at computers on the different school networks.

In one embodiment, received data can be analyzed to determine data various things, including data regarding the computers, and/or the computers that are served by a network device.

In one embodiment, received data can be analyzed to determine, for each respective network device, data regarding the computers that are served by the respective network device of a plurality of network devices.

Various types of data can be collected (e.g., from computers on different school networks). For example, in an embodiment involving downloads or other copying, the name of the file being, e.g., downloaded (e.g., to a hard drive of a computer) can be determined. In an embodiment involving downloads of music, the acoustical signature of the music file can be used in a known manner to determine the actual song being downloaded. In an embodiment involving downloads of files which may be protectible by digital rights management or other indications of legality, the legality of the downloaded file can be determined or estimated.

Also in an embodiment involving downloads or other copying, it can be determined whether a particular computer is, e.g., searching for particular content on many sites, attempting to download the content from multiple sites, repeatedly attempting to download the content. The time between attempts can further be determined, with a shorter time duration between attempts generally indicating a stronger demand for the content.

When data from different computers is received, the data can be analyzed to determine various information about groups of computers, including trends on, e.g., (statistical) averages of various data.

In one embodiment, the received data may be analyzed to determine geographic information about downloads (e.g. what types of downloads occur in different geographic areas). This can be possible where the (actual or assumed) geographic area of a computer is known or determinable. For example, in a trust system or other system that serves a particular network, the data that comes from a network may allow a determination or estimation that all or substantially all of the computers are located in a certain geographic area. For example, networks serving schools or companies may be assumed to serve computers that are all or approximately all located in a particular geographic area. Accordingly, data collected from such computers can be associated with the determined, estimated or assumed geographic area of those computers. For example, information representing various types of demand, when collected from a set of computers determined to be in a certain geographic area, can be correlated with the demand of users in that geographic area.

In one embodiment, the received data may be analyzed to determine school information about downloads. For example, in a trust system or other system that serves a school network, the data which comes from the network is known to originates from computers, e.g., of students, of faculty, of employees. In many network configurations, the type of user (e.g. faculty, student, employee) is determinable by the network (e.g. various subnets are restricted to a certain type of user).

Similarly, in an embodiment where the data originates from a network of a school, the received data may be analyzed to determine student status information about downloads. For example, the fact that a certain number of students downloaded a particular file may be important in many applications.

In one embodiment, the received data may be analyzed to determine popularity of particular content. For example, a number of downloads of, e.g., a particular song may be determined, and more specifically may be determined per period of time (e.g. each month) and/or per school. Thus, demand at various schools for the same or similar content may be compared.

In one embodiment, the received data may be analyzed to determine the legality of various downloads. For example, the data may be analyzed to determine, e.g., the number of illegal downloads, such as copyright infringement or unlicensed downloads, the number of illegal downloads within a certain area (e.g. a particular school), the proportion of all downloads which are illegal, the proportion of all songs which are illegal, the proportion of all songs within a certain area (e.g. a particular school) which are illegal, the number of illegal downloads of particular content (a particular movie) or type of content (songs, movies), the number of illegal downloads of particular content-or type of content within a certain area In one embodiment, the received data may be analyzed to determine ‘conversions’ (e.g., conversions from illegal downloads to legal acquisitions). For example, in an embodiment where downloaders of content can be offered a chance to legally acquire the content they have downloaded. An acceptance could be deemed a conversion to a legal acquisition. The number and/or proportion of such conversions can be measured, and can more specifically be measured for different geographic areas and/or for different networks (e.g., the conversions for two schools can be compared).

In one embodiment, the received data may be analyzed to determine strength of demand of particular content. For example, whether the content is frequently sought indicates the strength of demand.

In an embodiment where downloaders can be offered a chance to make a purchase (e.g. legally acquire certain content they have downloaded), the received data may be analyzed to determine the amount (e.g., average amount, aggregate amount) spent by individuals, or by certain individuals (e.g. in a geographic area).

In one embodiment, the received data may be analyzed to determine (absolute or relative) download activity (or download activity for particular content) after a particular event (e.g. a concert). Such a determination may be made with respect to a particular geographic area (e.g. the area near the concert). Accordingly, one could, for example, determine, for a plurality of songs of a certain band, determine the download activity of each song of that band for the geographic area near the concert.

Each of the above can be measured for particular time periods, and accordingly different time periods may be compared.

In general, various embodiments disclosed in this application permit one of ordinary skill in the art to determine many types of statistics, such as each of those statistics measured for the music industry, including the data collected by Billboard®, the Billboard Hot 100®, Billboard Research and the Entertainment News Wire.

In addition to determining and utilizing data about copies made to computers, other embodiments would permit, in a straightforward manner, the determination of, e.g. plays of a file (e.g. music, video), install of a files (e.g. periodically scanning the hard drive to determine what new file or what files were deleted), and like activity.

In one embodiment, the user of the computer can deliberately indicate what content they are downloading, or are playing, etc. For example, the user may interact with a program that requests permission to transmit collected information (e.g. to a server). Alternatively, the user may interact with a program that allows the user to enter information regarding, e.g. what content they are downloading, or are playing, and then that information is transmitted (e.g. to a server).

In one embodiment, information collected for a multiplicity of computers may be displayed in various manners. For example, the information may be displayed on/overlaid on a representation of a geographic map (e.g., a map of the United States). The information may be color-coded (e.g. one color indicated high proportions/numbers of illegal downloads). The information may be displayed in any other manner, including bar graphs, line graphs, reports, tables and the like.

Displays may indicate many information described herein, such as a running total of downloads, illegal downloads, downloads which were converted to legal downloads, and/or revenue generated by conversions to legal acquisitions.

9.2 A Trust System

An embodiment of a trust system is described below. Such a trust system can identify and/or deal with qualifying data on devices that access networks through (at least) two components: a “gate” and an “agent.”

The gate can be a device that includes one or many pieces of equipment. The device may have custom software installed to run its operating system. It will typically be installed on a network at a strategic point before information is allowed to exit the network and disseminate onto the Internet or other network. A function of the gate is to regulate Internet access and other resource access for the users of the network. Another function of the gate is to ensure that users are complying with a predetermined policy before access to the Internet, to freely shared information or to other network resources is granted. In some embodiments the gate could actually be software that is installed on a network in a known manner.

The agent includes software that runs on devices, and which continually monitor the computer for the presence of qualifying data. As an example, qualifying data may be, but not limited to, illegally downloaded music. Once the qualifying data is discovered, several steps may ensue. An example may be that the qualifying data is deleted from the machine and the user referred to a web site that, e.g., explains the deletion, and then offers ways to obtain the information in an approved (e.g., legal) manner.

9.3 The Gate

In one embodiment a Gate performs the following functions:
1. The gate will receive requests from individual devices to access data across a network.
2. The gate ensures that the individual devices are entrusted to access the network. An example of one way of determining if an individual device should be entrusted is if the individual device is running a certain piece of software. There are other ways of determining trust (additionally or alternatively).
3.If the individual device is not entrusted, the individual device will be denied access to one or more services across the information network.

The functions of the Gate may also include, but are not limited to, the following:
1. Typical installation of the Gate occurs at a point between individual devices and the main router providing access to the internet.
2. The gate recognizes if an individual device that is attempting to access the internet through the network does not have the agent running.
3. The gate can host and serve a web page for the individual device to download and install the agent.
4. The gate has a web server available to provide the user with information (e.g., a web page) describing a means for the user to acquire and install the agent. For example, the information may direct the user to a web page where the agent may be downloaded, and then installed on the user's device.
5. After the agent is installed, the gate will ensure that the agent is continually running on the individual device. It does this by receiving and verifying certain communication packets from the individual device. For example, the communication packets from the device may include encrypted information verifying that the agent has not been altered or otherwise tampered with.
6. If the individual device machine is not running the agent, the gate can, e.g., deny the individual device any internet access and/or access to other network resources and services.
7. The gate also provides updates to the Agent software (both content and program). Such updates include, but are not limited to, updates to the execution code of the Agent and any data needed to identify qualifying data (e.g., fingerprints of qualifying data).
8. The gate updates its own execution code and data by periodically contacting a designated update server (e.g., a server operated by an entity that sells or manufactures the gate).
9. The gate may also host a web site that provides information to a user concerning any qualifying data, any action taken to the qualifying data, and/or any offers made to the user to obtain material in an approved manner.
   9.4 The Agent

In one embodiment, the agent is software installed on any number of individual devices. In one embodiment the agent performs the following steps:
1. Identifies if qualifying data is accessed by the individual device.
2. Once identified, the agent may do any or all of the following:
   a. Gather additional information about the qualifying data.
   b. Provides additional information to an end user through the individual device (e.g., the user's computer).
   c. Apply DRM (Digital Rights Management) to any qualifying data.
   d. Render the qualifying data inaccessible.
   e. Prevent sharing and/or dissemination of the qualifying data.

By way of further illustration, the agent may also be programmed to perform any or all of the following functions:
Install itself on an individual device.
Establishes a communication channel with the gate to ensure continued operation.
(Immediately) after initial installation, scans the individual device for qualifying data.
Checks any qualifying data for appropriate action. Such checking can be through information on the user's machine or through databases on a network based server.
Depending on the qualifying data and the actions described in the databases, the qualifying data may be rendered unusable on the individual device.
Depending on the qualifying data, the qualifying data may also be marked for tracking purposes with watermarks, digital rights management, etc.
Depending on the qualifying data, the agent may present additional information to the user. Such information may inform the user about what was done to the qualifying data (erased, rendered unusable, etc.) and present means for the user to obtain legitimate material.
The agent also communicates with the Gate for updates to its software and to its information stores.
   9.5 A Download Assistant

A program (which may but need not be an Agent, and which may but need not include an Agent) running on a device can identify copying in progress of files (e.g., audio files) and can estimate/identify what content (e.g. which song) the file is using known fingerprinting techniques (e.g., by determining the acoustical signature of a file and comparing that signature with a set of known signatures).

A peer-to-peer program, or other file distribution program, can display a list of songs or other files that are available for download. These listed files are essentially files stored in folders (e.g., on other computers) that have been made available to the P2P network. The list in a peer-to-peer program, or other file distribution program, typically provides information such as
a) file name (as named on the source computer),
b) song title (as stored in the file itself)
c) duration of song (if applicable)
d) size of the file
e) estimated bandwidth of communication with the source computer

The user of P2P software can install an Agent (or other program thought the term Agent is used hereafter) on his device, and the Agent can fingerprints all music files, video files, etc., whether such files are incoming (downloading) or outgoing (uploading/placed in user's ‘Shared’ folder). The Agent may but need not be a part of the P2P program (or other file distribution program). The Agent and may but need not include the P2P program (or other file distribution program).

Upon download of content, the Agent can determine what is being downloaded (or otherwise copied to the device) after a portion is downloaded. For example, the acoustical signature or other fingerprint of the partially-copied file may be determined (within an acceptable range of accuracy) to match a known fingerprint. This may be used to ensure that the song (or other content) being downloaded (which might consume precious bandwidth of the user's network connection) is indeed what the user wanted.

In addition, when a file is made available (e.g., uploaded/placed in user's ‘Shared’ folder) to the P2P public, that file can carry information regarding its ‘authenticity’ (e.g., a computer running an Agent can generate a verifiable certificate of authenticity for the file, such as may be produced by a cryptographic algorithm). Then, when users searches for a song and certain files are returned as search results, the P2P software can determine whether a certificate of authenticity is included with each file returned as a search result. Such files could be displayed with a different icon color, a different icon, etc. to indicate their authenticity to other users on the P2P network (or other network).

Thus the identity of a song can be determined on a P2P network. Multiple variants of the same song can be identified, tracked and even rated (e.g. by P2P users). For example, users could use an HTML form on a web page to rate the ‘quality’ of variants of a song.

Why Would a P2P User Run the Agent?

People using P2P software can benefit from an Agent (with its fingerprint capabilities) so they can identify/fingerprint the song files they download. Such a program could be part of the P2P software, or could be separate from the P2P software. Many other types of downloading software and file distribution software besides P2P software may be used, although the term “P2P” software is used for simplicity.

If a P2P software user has the Agent running on his device, then the Agent can notify the user if, e.g., it appears the wrong file is being downloaded. For example, during a download the user could abort the download operation after a few seconds if it appears the wrong song is being downloaded (e.g., incorrect filename, the file is malicious RIAA spam file). This capability would give P2P users a reason to install the Agent and keep it running unimpeded since the Agent verifies their downloads and so conserves their bandwidth and time.

Since the Agent is running (e.g., in order to verify downloads), the Agent might also ensure that uploads are accurate (or at least easily verifiable) by “pre-fingerprinting” songs which are made available for distribution (placed in the Shared folder). The fingerprint of a file could be made available to other P2P software users, e.g., when a search results in a ‘hit’ on that file and therefore the file should be included in a list of search results. This capability can reduce or eliminate the need to fingerprint songs as they download, since they are already fingerprinted on upload. It is even more advantageous if the fingerprinting is verifiable by other Agents, so that the Agents can trust the fingerprint (e.g., and thus the other Agents need not fingerprint the file as it downloads, but instead use the fingerprint of the file provided by the other agent which created the fingerprint). Pre-fingerprinted songs may be indicated in various manners (e.g., different icon, different color) by the P2P software.

Since users typically don't care when a song is made available for sharing, it would be acceptable to many users if fingerprinting were a background task (e.g., that took several seconds to complete for each song that is placed in the “Shared” folder or otherwise made available to others). Once fingerprinting is completed (e.g., several seconds later), the file would actually be available for downloading by others. Of course, a song downloaded from a trusted site could already be fingerprinted, so no additional fingerprinting would be necessary.

Thus, in such an embodiment, the agent does something for P2P users upon download, and so users allow the Agent to perform other functionality on their device (e.g. referrals, statistics collection).

The Agent Can Also be the Gate

In an embodiment, other clients running the Agent could also perform some functions of the Gate by determining if data received from another client is “trusted”. For example, one agent can received the “heartbeat” (Agent's code of authenticity that verifies is has not been tampered with) from another Agent, and determine if the heartbeat indicates that the other Agent has not been tampered with.

In an embodiment, P2P software might attach a rating to people if they are “trusted” (e.g., if people are running the Agent).

In an embodiment, P2P software might require every user of the P2P software to install and run the Agent. For example, the P2P software, upon installation on a computer, could determine whether the Agent was installed and running, and if not require the computer to install and run the Agent. Another variation would be that the P2P software itself performs some or all of the functions of the Agent.

In an embodiment, the Agent can also inform the user that a file in the search results window (e.g., about to download) is trusted (e.g., from another device running the Agent). For example, gold icons could appear next to files that originate from computers that are running the Agent.

In an embodiment, a device running P2P software and running the Agent can log on to a “trusted” circle, in which only users who are trusted could upload to or download from the trusted circle. Thus, files uploaded by “trusted” devices can be tagged with a code indicating they are trusted files, can only be downloaded by “trusted” devices. Alternatively, the P2P client which is running the Agent might have the option to confine search results to the “trusted” circle of files.

Other Features of P2P Agent Software

In an embodiment, it can take more than a negligible amount of time to recognize a song for two reasons:
(i) FINGERPRINTING THE SONG—a sufficient portion of the file (e.g. 5 seconds of play time of a song) might have to be downloaded in order to reliably determine (e.g., determine within a range of acceptable accuracy) which song it is. As more of the song is downloaded, the ability to accurately recognize the song (and/or the accuracy of the determination) increases.
(ii) SEARCHING THE FINGERPRINT DATABASE—the fingerprint database might be large and so it might take more than a negligible amount of time to compare a fingerprint with the entries in the database.

During the delay in recognizing a song or other file, the Agent can display information to the user in a ‘progress’ window. For example, a progress window might indicate, for each song download in progress, the ‘guesses’ as to which song is actually being downloaded. As recognition accuracy increases, the list of possibilities shrinks until the definitive song title is left. This information is useful to the user because it allows him to halt copies that are clearly not what was desired.

However, if songs are pre-fingerprinted (as described above) upon upload, then the first component (fingerprinting the songs) can be eliminated on downloads, and so the only time delay is in searching the database. This might also be unnecessary if the trust is established (e.g., one would know that the pre-fingerprinting process has not only correctly fingerprinted the song but has also tagged it with the proper title and artist information).

P2P Software Can Search for Fingerprints

In one embodiment, searching for files (e.g., in a file distribution network) could employ (i) the fingerprint of the file searched for, and/or (ii) the fingerprints of the files being searched. The Agent can include or have access to a fingerprint database which includes files, fingerprints of files, and associated referral data. This database could be modified to include ‘standard’ song title and artist information (for files which represent, e.g., songs or music videos). When a user searches for, e.g., a particular song title, the associated fingerprint is retrieved and the fingerprint is used to search the network.

Such a process more rigorously indicates what file the user is actually searching for. Thus, downloads can be stopped quicker if it is determined that the proper file is not being downloaded. Also, the actual demand for particular files is more accurate. Thus, file names need not be, e.g., mapped onto songs in the search process since the user has already done that by choosing the desired song from the fingerprint database and having the fingerprint included in the search.

Such an embodiment can reduce problems with ‘spoofing’—the designation of content with a misleading or inaccurate file name.

Rating the Accuracy of Filenames

In an embodiment, when a user halts a download, this can indicate that a file name was ‘misleading’ to this user. If a sufficient number of users halt a download of the misleading file, the file could be tagged as SPAM or otherwise denoted as having a file name that is misdescriptive. For example, a file could include an associated reliability rating (e.g., 2 out of 5 stars) that is generated from the ‘votes’ of P2P users who tried to copy that file. A variety of known SPAM filter technology could be brought to bear in such a democratic rating/tagging scheme. There could also be a number of community rating techniques, such as the rating technique Amazon.com uses to allow people to rate products sold by Amazon. COM (e.g., a person may apply a star rating to a product and/or may apply a text describing the product, its quality, etc.).

In an embodiment, users who provide files that are designated as SPAM can be notified, warned, tagged, downgraded in status or banned, as appropriate. Files made available by users who are ‘tagged’ as a SPAM providers can be indicated (e.g., listed in a different color than other files), thereby warning other users.

Thus, bad files can be quickly discovered and their proliferation reduced. Any P2P software (or other file distribution software) could benefit from such a SPAM filtering feature or accuracy rating feature. Any P2P software would also benefit from generating a stronger community, as would result from an accuracy rating scheme.

In an embodiment, each fingerprint in an Agent's fingerprint database could be associated with a song name and artist. Then the Agent could also correct spelling, etc. of file names after it downloads, if desired, using known algorithms for checking the accuracy of spelling. (the device provides a dialog box asking the user “You've downloaded BADLANDS but the filename is spelled BADLANSD—fix the file name?”) Thus, if the downloading device makes that file (with corrected file name) available to others, it will have a properly spelled filename for others.

In an embodiment, the color of the icon in a listing of searched-for files can indicate various information. Different colored icons could indicate “trusted”/“reliable” files, fingerprinted files, the ‘user rating’ of files, etc.

In an embodiment, since each song and its variants could be identified, the P2P community could rate the quality of the variants, and such quality rating could be associated with the file. Thus, when searching for files, search results could be sorted by ‘quality’ as determined by the popular vote of the community. The device could notify users of quality (e.g., “Copy A of Badlands is much better than Copy B”, or “Copy A of Badlands is missing the final refrain”, or “Most people have halted downloads of this variant”). Thus, information on subjective song quality could be conveyed from the user to the P2P community.

An advantage of employing fingerprinting (e.g., via an Agent) with P2P software is that music can be automatically identified before a download of a file is completed. This would tend to reduce the effectiveness of the practice of releasing files which purport to be popular songs but are not (e.g. they contain shrill noise).

In an embodiment, a possible tactic would be to make the “bad” files (which pretend to be certain content) close enough approximations to the content to fall within the applicable ‘threshold’ in the fingerprint algorithm. For example, one tactic could be to splice in short durations of noise that are spaced far apart. Another would be to alter the audio properties of the song in a manner that minimizes the affect on the fingerprint (perhaps randomly varying the volume, inserting white noise, randomly varying the pitch).

In an embodiment, the fingerprint algorithm can be made adaptive such that it filters SPAM music, as described above. If many users vote the music as misleading, it is flagged as having a low reliability.

10. Description of Various Embodiments

A wide variety of embodiments of the invention have been described in detail above. In this Section 9, many embodiments are described. Some or all of the embodiments described below may encompass embodiments described above. Some or all of the embodiments described below may be equivalent to embodiments described above.

Each of the embodiments below (in method, apparatus and medium forms) is indicated by a unique number or combination of numbers. Some of the embodiments below refer to other embodiments in this Section 9.

1. A method comprising:

determining whether there is an attempt by a device to access qualifying data; and
if there is an attempt by the device to access qualifying data, performing at least one of the following steps:
(a) providing an offer to purchase an item (e.g., forward to web site which presents an offer),
(b) providing additional information about the qualifying data (e.g., what was done to the qualifying data, how to obtain a legitimate copy of the qualifying data),
(c) applying DRM to the qualifying data,
(d) rendering the qualifying data inaccessible (e.g., delete, alter),
(e) preventing dissemination of the qualifying data (e.g., remove it from a ‘shared’ folder, delete it)
(f) gathering information about the qualifying data
   1.1 The method of embodiment 1, in which
determining whether there is an attempt by a device to access qualifying data comprises:
reading data; and
determining whether the read data includes qualifying data.
   1.1.1 The method of embodiment 1.1, in which
determining whether the read data includes qualifying data comprises:
creating a fingerprint that is based on the read data; and
comparing
   (i) the fingerprint that is that is based on the read data
with
   (ii) at least one fingerprint of a plurality of fingerprints.
      1.1.1.1 The method of embodiment 1.1.1, in which
creating a fingerprint that is based on the read data comprises:
creating a fingerprint that is based on perceptual audio features of a plurality of frames,
in which each frame represents a portion of the duration of the read data.
   1.1.1.2 The method of embodiment 1.1.1, in which
creating a fingerprint that is based on the read data comprises:
segmenting the read data into a plurality of frames;
for each of the frames, computing a set of features; and
mapping each set of features to a sub-fingerprint.
   1.1.1.2.1 The method of embodiment 1.1.1.2, in which each frame represents 11.6 milliseconds of read data, thereby rendering 256 sequential sub-fingerprints for a representation of about 3 seconds of read data.
   1.1.2 The method of embodiment 1.1, in which
determining whether the read data includes qualifying data comprises:
reading across a network to a stored plurality of fingerprints.
   1.1.3 The method of embodiment 1.1, in which
determining whether the read data includes qualifying data comprises:
reading a locally-stored plurality of fingerprints.
   1.1.3.1 The method of embodiment 1.1.3, further comprising:
updating the local database of fingerprints.
   1.2 The method of embodiment 1, in which
determining whether there is an attempt by a device to access qualifying data comprises:
determining at least one parameter of a search for data; and
determining whether the at least one parameter indicates a particular kind of qualifying data.
   1.2.1 The method of embodiment 1.2, in which the determining at least one parameter of a search comprises
determining at least one parameter of a search for data that is not stored locally .
   1.2.1.1 The method of embodiment 1.2.1, further comprising:
receiving at least one search result.
   1.2.1.1.1 The method of embodiment 1.2.1.1, further comprising:
transmitting a request to receive data corresponding to the at least one search result.
   1.2.1.1.1.1 The method of embodiment 1.2.1.1.1, further comprising:
receiving data corresponding to the at least one search result.
   1.2.1.2 The method of embodiment 1.2.1, in which determining at least one parameter of a search for data that is not locally stored comprises:
determining at least one key word that is transmitted to a search engine via a web browser.
   1.2.1.3 The method of embodiment 1.2.1, in which determining at least one parameter of a search for data that is not locally stored comprises:
determining at least one parameter of a search query directed to a file-sharing network.
   1.2.1.3.1 The method of embodiment 1.2.1.3, in which the parameter is a key word
   1.2.1.3.2 The method of embodiment 1.2.1.3, in which the file-sharing network is a peer-to-peer file-sharing network.
   1.3 The method of embodiment 1, in which
determining whether there is an attempt by a device to access qualifying data comprises:
determining whether there is an attempt by a device to store the qualifying data.
   1.3.1 The method of embodiment 1.3, in which an attempt by a device to store the qualifying data comprises:
determining that there is an attempt to store the qualifying data to at least one of a hard drive, a removable media recorder, and a random access memory.
   1.3.2 The method of embodiment 1.3, in which an attempt by the device to access qualifying data comprises:
an attempt to transmit the qualifying data to a peripheral device.
   1.3.3 The method of embodiment 1.3, in which an attempt by the device to store the qualifying data comprises:
an attempt to access a function of an operating system running on the device,
   in which the function of the operating system includes a function that is executed for substantially every write command to a storage medium.
      1.3.4 The method of embodiment 1.3, in which an attempt by the device to store the qualifying data comprises:
an attempt to access a function of an operating system running on the device,
in which the function of the operating system includes a function executed for every write command to a storage medium.
   1.3.5 The method of embodiment 1.3, in which an attempt by the device to store the qualifying data comprises:
an attempt to access a function of an operating system running on the device,
in which the function of the operating system includes a function executed for every of a particular type of write command.
   1.3.6 The method of embodiment 1.3, in which an attempt by the device to store the qualifying data comprises:
an attempt to access a function of an operating system running on the device,
in which the function of the operating system includes a function executed for every write command to a particular storage medium.
   1.3.7 The method of embodiment 1.3, in which an attempt by the device to store the qualifying data comprises:
an attempt to access a function of an operating system running on the device,
in which the function of the operating system includes a function executed for every write command to every storage medium accessible to the device.
   1.3.8 The method of embodiment 1.3, further comprising:
determining that there is an attempt by a device to store a set of data;
reading the set of data; and
determining whether the read set of data includes qualifying data.
   1.10 The method of embodiment 1, in which
determining whether there is an attempt by a device to access qualifying data comprises:
reading data; and
determining whether the read data represents a multimedia file.
   1.10.1 The method of embodiment 1.10, in which determining whether the read data represents a multimedia file comprises:
determining whether a file extension of the read data indicates a multimedia file.
   1.11 The method of embodiment 1, in which
determining whether there is an attempt by a device to access qualifying data comprises:
reading data; and
determining whether the read data includes digital rights management.
   1.11.1 The method of embodiment 1.11, in which
determining whether there is an attempt by a device to access qualifying data comprises:
reading data;
determining that the read data represents a multimedia file;
determining that the read data corresponds to a copyrighted work; and
determining that the multimedia file does not include digital rights management.
   1.12 The method of embodiment 1, in which
determining whether there is an attempt by a device to access qualifying data comprises:
reading data; and
determining a source of the read data.
   1.12.1 The method of embodiment 1.12, in which determining a source of the read data comprises:
comparing the source to a set of predetermined sources.
   1.12.1.1 The method of embodiment 1.12.1, in which comparing the source to a set of predetermined sources comprises:
determining a URL of the source; and
comparing the URL with a plurality of predetermined URLs.
   1.20 The method of embodiment 1, in which qualifying data comprises at least one of:
data representing music,
data representing video, and
data representing a written work.
   1.21 The method of embodiment 1, in which qualifying data comprises:
a software program.
   1.22 The method of embodiment 1, in which qualifying data comprises a work that is copyrightable.
   1.4 The method of embodiment 1, in which the step of
if there is an attempt by the device to access qualifying data, performing comprises:
providing an offer to purchase an item if there is an attempt by the device to access qualifying data.
   1.4.1 The method of embodiment 1.4, in which providing an offer to purchase an item comprises:
providing an offer to purchase an item that corresponds to the qualifying data.
   1.4.1.1 The method of embodiment 1.4.1, in which providing an offer to purchase an item that corresponds to the qualifying data comprises:
determining a work of authorship which corresponds to the qualifying data; and
providing an offer to purchase the work of authorship.
   1.4.1.1.1 The method of embodiment 1.4.1.1, in which providing an offer to purchase an item that corresponds to the qualifying data comprises:
determining a work of music which corresponds to the qualifying data; and
providing an offer to purchase the work of music.
   1.4.1.1.1.1 The method of embodiment 1.4.1.1.1, in which determining work of music which corresponds to the qualifying data comprises at least one of:
determining a song,
determining a song and an artist who performed the song, and
determining a song, an artist who performed the song, and a particular rendition by the artist of the song.
   1.4.1.2 The method of embodiment 1.4.1, in which providing an offer to purchase an item that corresponds to the qualifying data comprises:
determining that the qualifying data represents a multimedia file; and
providing an offer to purchase the multimedia file.
   1.4.2 The method of embodiment 1.4, in which providing an offer to purchase an item that corresponds to the qualifying data comprises:
providing a system for receiving from a user a response to the offer.

1.4.2.1 The method of embodiment 1.4.2, in which providing an offer to purchase an item that corresponds to the qualifying data comprises:
providing a component of a graphical user interface that, when clicked, represents acceptance of the offer.
   1.4.3 The method of embodiment 1.4, further comprising:
receiving an acceptance of the offer.
   1.4.4 The method of embodiment 1.4, further comprising:
facilitating the purchase of the item.
   1.4.4.10 The method of embodiment 1.4.4, in which facilitating the purchase of the item comprises
determining if an acceptance of the offer has been received; and
facilitating the purchase of the item if an acceptance of the offer has been received.
   1.100 The method of embodiment 1, further comprising:
referring to a predetermined web site.
   1.100.1 The method of embodiment 1.100, in which referring to a predetermined web site comprises:
referring to a web site from which item may be purchased.
   1.110 The method of embodiment 1, further comprising:
redirecting a browser to a predetermined URL.
   1.120 The method of embodiment 1, further comprising:
providing a hyperlink that, when clicked on, directs a browser to a predetermined URL.
   1.130 The method of embodiment 1, further comprising:
providing an offer to purchase the qualifying data.
   1.12 The method of embodiment 1, further comprising:
providing an offer to purchase a product defined by the qualifying data.
   1.5 The method of embodiment 1, further comprising
determining whether the device stores qualifying data.
   1.5.1 The method of embodiment 1.5, in which determining whether the device stores qualifying data comprises:
determining whether a persistent storage peripheral device of the device stores qualifying data.
   1.5.1.1 The method of embodiment 1.5.1, in which determining whether a persistent storage peripheral of the device stores qualifying data comprises:
reading a file directory which describes a plurality of files stored on a hard drive of the device; and
determining whether any of the plurality of files comprises qualifying data.
   1.5.1.1.1 The method of embodiment 1.5.1.1,in which determining whether any of the plurality of files comprises qualifying data comprises:
reading each of the plurality of files; and
determining, for each of the read files, whether the read file includes qualifying data.
   1.5.1.2 The method of embodiment 1.5.1, in which determining whether a persistent storage peripheral of the device stores qualifying data comprises:
reading a file directory which describes a plurality of files stored on a hard drive of the device; and
determining whether any of the plurality of files represents a multimedia file.
   1.6 The method of embodiment 1, in which determining whether there is an attempt by a device to access qualifying data comprises:
determining whether the device has issued a command to access qualifying data.
   1.7 The method of embodiment 1, in which determining whether there is an attempt by a device to access qualifying data comprises:
determining whether the device has issued a request to access qualifying data.
   1.8 The method of embodiment 1, in which the step of
if there is an attempt by the device to access qualifying data, performing comprises:
providing an offer to play a media file if there is an attempt by the device to access qualifying data.
   1.8.1 The method of embodiment 1.8, in which providing an offer to play a media file comprises:
providing an offer to play a media file that corresponds to the qualifying data.
   1.8.1.1 The method of embodiment 1.8.1, in which providing an offer to play a media file that corresponds to the qualifying data comprises:
determining a media file which corresponds to the qualifying data; and
providing an offer to play the media file.
   1.8.1.1.1 The method of embodiment 1.8.1.1, in which providing an offer to play a media file that corresponds to the qualifying data comprises:
determining a work of music which corresponds to the qualifying data; and
providing an offer to play the work of music.
   1.8.1.1.1.1 The method of embodiment 1.8.1.1.1, in which determining work of music which corresponds to the qualifying data comprises at least one of:
determining a song,
determining a song and an artist who performed the song, and
determining a song, an artist who performed the song, and a particular rendition by the artist of the song.
   1.8.1.2 The method of embodiment 1.8.1, in which providing an offer to play a media file that corresponds to the qualifying data comprises:
determining that the qualifying data represents a multimedia file; and
providing an offer to play the multimedia file.
   1.8.2 The method of embodiment 1.8, in which providing an offer to play a media file that corresponds to the qualifying data comprises:
providing a system for receiving from a user a response to the offer.
   1.8.2.1 The method of embodiment 1.8.2, in which providing an offer to play a media file that corresponds to the qualifying data comprises:
providing a component of a graphical user interface that, when clicked, represents acceptance of the offer.
   1.8.3 The method of embodiment 1.8, further comprising:
receiving an acceptance of the offer.
   1.8.4 The method of embodiment 1.8, further comprising:
facilitating the playing of the media file.
   1.8.4.10 The method of embodiment 1.8.4, in which facilitating the playing of the item comprises
determining if an acceptance of the offer has been received; and
facilitating the playing of the media file if an acceptance of the offer has been received.

1.8.5 The method of embodiment 1.8, further comprising:
executing software which is capable of playing media files.

1.8.5.1 The method of embodiment 1.8.5, further comprising:
directing the software to play the media file.
   1.200 The method of embodiment 1, further comprising:
recording data that indicates referrals.
   1.205 The method of embodiment 1, further comprising:
recording data that indicates redirects.
   1.210 The method of embodiment 1,further comprising:
recording data that indicates acceptances of offers.
   1.220 The method of embodiment 1, further comprising:
recording data that indicates the qualifying data.
   2. A computer-readable medium which stores instructions capable of being executed by a computing device, wherein the instructions, when executed, direct the computing device to perform the method of embodiment 1.
   2.1 The computer-readable medium of embodiment 2, further comprising:
means for assuring that the instructions are executed unimpeded.
   3. An apparatus comprising:
at least one microprocessor and
a memory readable by the at least one microprocessor, the memory storing instructions which are performable by the at least one microprocessor, in which the instructions direct the at least one microprocessor to perform the method of embodiment 1.
   4. A system comprising:
a computing device; and
a plurality of the apparatus of embodiment 3, the computing device being capable of communicating with each of the plurality of apparatus,
   in which the computing device stores an indication of a plurality of qualifying data, and
   in which the computing device is operable to transmit the indication to at least one of the plurality of apparatus.
      4.1 The system of embodiment 4, in which the computing device is operable to determine, for each apparatus of the plurality of apparatus, whether it is necessary to transmit the indication to the respective apparatus.
      5. A method comprising:
determining whether a device stores qualifying data; and
if the device stores qualifying data, performing at least one of the following steps:
(a) providing an offer to purchase an item (e.g., forward to web site which presents an offer),
(b) providing additional information about the qualifying data (e.g., what was done to the qualifying data, how to obtain a legitimate copy of the qualifying data),
(c) applying DRM to the qualifying data,
(d) rendering the qualifying data inaccessible (e.g., delete, alter),
(e) preventing dissemination of the qualifying data (e.g., remove it from a ‘shared’ folder, delete it)
(f) gathering information about the qualifying data
(g) providing an offer to play a media file (e.g., activate a media player to play a certain song)
   5.1 The method of embodiment 5, in which determining whether a device stores qualifying data comprises:
reading a file stored by the device; and
determining whether contents of the file define predetermined content.
   5.1.1 The method of embodiment 5.1, in which determining whether contents of the file define predetermined content comprises:
determining whether a portion of the contents match predetermined contents.
   5.1.2 The method of embodiment 5.1, in which determining whether contents of the file define predetermined content comprises:
determining audio features from the contents.
   5.1.3 The method of embodiment 5.1, in which determining whether contents of the file define predetermined content comprises:
determining perceptual audio features from the contents.
   5.2 The method of embodiment 5, in which determining whether a device stores qualifying data comprises:
determining a file name of a file stored by the device.
   5.3 The method of embodiment 5, in which determining whether a device stores qualifying data comprises:
determining a file extension of a file stored by the device.
   6. A method comprising:
receiving an indication of a music file;
storing the indication of the music file;
receiving an indication of a fulfillment node;
storing the indication of the fulfillment node;
reading data;
comparing the read data with the stored indication of the music file;
determining that the read data matches the stored indication of the music file; and
referring to the fulfillment node.
   6.1 The method of embodiment 6, in which referring to the fulfillment node comprises:
facilitating a purchase of an item from a merchant that is defined by the stored indication of the fulfillment node.
   6.2 The method of embodiment 6, in which the indication of the fulfillment node defines a web site; and
in which referring to the fulfillment node comprises:
   referring to the web site defined by the fulfillment node.
      6.2.10 The method of embodiment 6.2, in which referring to the web site comprises:
redirecting a browser to a URL defined by the stored indication of the fulfillment node.
   6.2.20 The method of embodiment 6.2, in which referring to the web site comprises:
providing a hyperlink that, when clicked on, directs a browser to the predetermined web site.
   6.2.30 The method of embodiment 6.2, in which referring to the web site comprises:
redirecting a browser to a URL that is defined by:
   the stored indication of the fulfillment node, and
   the read data.
      6.2.40 The method of embodiment 6.2, in which referring to the web site comprises:
redirecting a browser to a URL that is defined by:
   the stored indication of the fulfillment node, and
   the indication of the music file.
      6.100 The method of embodiment 6, in which the indication of the music file comprises:
a fingerprint of the music file.
   6.102 The method of embodiment 6, in which the indication of the music file comprises:
a fingerprint of at least one portion of the music file.
   6.105 The method of embodiment 6, in which the indication of the music file comprises:
a copy of the music file.
   6.110 The method of embodiment 6, in which the indication of the music file comprises:
a name of music defined by the music file.
   6.115 The method of embodiment 6, in which the indication of the music file comprises:
a portion of a name of music defined by the music file.
   6.120 The method of embodiment 6, in which the indication of the music file comprises:
a name of an artist defined by the music file.
   6.125 The method of embodiment 6, in which the indication of the music file comprises:
a portion of a name of an artist defined by the music file.
   6.200 The method of embodiment 6, in which the indication of the fulfillment node comprises:
a URL.
   6.200.1 The method of embodiment 6.200, in which the indication of the fulfillment node comprises:
a plurality of indications of a song; and
for each indication of a song, a corresponding URL.
   6.205 The method of embodiment 6, in which the indication of the fulfillment node comprises:
a name of a merchant.
   7. A method comprising:
receiving, from a first party, information defining at least one file;
receiving, from a second party, information defining at least one fulfillment node;
reading data;
comparing the read data with the information defining at least one file;
determining that the read data corresponds to the information defining at least one file; and
referring to the at least one fulfillment node.
   7.10 The method of embodiment 7, in which the information defining at least one file comprises:
information defining at least one music file.
   7.10.1 The method of embodiment 7.10, in which the information defining at least one music file comprises:
a fingerprint of the music file.
   7.10.2 The method of embodiment 7.10, in which the information defining at least one music file comprises:
a fingerprint of at least one portion of the music file.
   7.10.3 The method of embodiment 7.10, in which the information defining at least one music file comprises:
a copy of the music file.
   7.10.4 The method of embodiment 7.10, in which the information defining at least one music file comprises:
a copy of at least one portion of the music file.
   7.10.5 The method of embodiment 7.10, in which the information defining at least one music file comprises:
a name of music defined by the music file.
   7.10.6 The method of embodiment 7.10, in which the information defining at least one music file comprises:
a portion of a name of music defined by the music file.
   7.10.7 The method of embodiment 7.10, in which the information defining at least one music file comprises:
a name of an artist defined by the music file.
   7.10.8 The method of embodiment 7.10, in which the information defining at least one music file comprises:
a portion of a name of an artist defined by the music file.
   7.50 The method of embodiment 7, in which receiving, from a second party, information defining at least one fulfillment node comprises:
receiving a URL.
   7.50.1 The method of embodiment 7.50, in which receiving, from a second party, information defining at least one fulfillment node comprises:
receiving
   a plurality of indications of a song, and
   for each indication of a song, a corresponding URL.
      7.60 The method of embodiment 7, in which receiving, from a second party, information defining at least one fulfillment node
receiving a name of a merchant.
   7.80 The method of embodiment 7, in which referring to the fulfillment node comprises:
facilitating a purchase of an item from a merchant that is defined by the information defining at least one fulfillment node.
   7.90 The method of embodiment 7, in which the information defining the at least one fulfillment node defines a web site; and
in which referring to the fulfillment node comprises:
   referring to the web site that is defined by the information defining the at least one fulfillment node.
      7.90.10 The method of embodiment 7.90, in which referring to the web site comprises:
redirecting a browser to a URL defined by the information defining the at least one fulfillment node.
   7.90.20 The method of embodiment 7.90, in which referring to the web site comprises:
providing a hyperlink that, when clicked on, directs a browser to the predetermined web site.
   7.90.30 The method of embodiment 7.90, in which referring to the web site comprises:
redirecting a browser to a URL that is defined by:
   the information defining the at least one fulfillment node, and
   the read data.
      7.90.40 The method of embodiment 7.90, in which referring to the web site comprises:
redirecting a browser to a URL that is defined by:
   the information defining the at least one fulfillment node, and
   the indication of the music file.
      7.100 The method of embodiment 7, in which receiving, from a first party, information defining at least one file comprises:
receiving, from a first party, information that defines:
   at least one file, and
   a fulfillment node that corresponds to the at least one file.
      7.105 The method of embodiment 7, in which receiving, from a first party, information defining at least one file comprises:
receiving, from a first party, information that defines:
   a plurality of files, and
   for each of the plurality of files, a corresponding fulfillment node.
      7.110 The methods of either of embodiments 7.100 or 7.105, in which referring to the at least one fulfillment node comprises:
determining a file that corresponds to the read data;
determining a fulfillment node that corresponds to the file; and
referring to the fulfillment node that corresponds to the file.
   7.110.1 The methods of embodiment 7.110, in which referring to the at least one fulfillment node comprises:
determining a song that corresponds to the read data;
determining a fulfillment node that corresponds to the song; and
referring to the fulfillment node that corresponds to the song.
   7.200 The method of embodiment 7, in which receiving, from a second party, information defining at least one fulfillment node comprises:
receiving, from a second party, information that defines:
   at least one fulfillment node, and
   at least one file.
      7.205 The method of embodiment 7, in which receiving, from a second party, information defining at least one fulfillment node comprises:
receiving, from a second party, information that defines:
   at least one fulfillment node, and
   a plurality of songs.
      7.300 The method of embodiment 7, in which the first party comprises the second party.
      7.305 The method of embodiment 7, in which the first party is the second party.
      7.400 The method of embodiment 7, further comprising:
receiving payment from the first party.
   7.405 The method of embodiment 7, further comprising:
receiving payment from the second party.
   7.410 The method of embodiment 7, further comprising:
charging the first party based on the received information defining at least one file.
   7.410.1 The method of embodiment 7.410, further comprising:
charging the first party based on a number of songs defined by the received information defining at least one file.
   7.415 The method of embodiment 7, further comprising:
charging the second party based on the received information defining at least one fulfillment node.
   7.415.1 The method of embodiment 7.415, further comprising:
charging the second party based on a number of referrals to the at least one fulfillment node.

1. A method comprising:
receiving, from a first party, information defining a plurality of music files;
providing the information defining the plurality of music files to each of a plurality of computers;
receiving first data from each of the plurality of computers;
determining, from the first data, that each of the plurality of computers is trusted;
receiving a set of respective second data from each trusted computer, in which each respective second data indicates that the corresponding trusted computer has stored, to a hard drive, a respective music file that was received via a peer-to-peer file-sharing network; and
outputting information based on the set of second data received from each trusted computer, in which the report includes the respective music files stored by the trusted computers.

2. The method of claim 1, in which the information defining the at least one music file comprises a fingerprint of the music file.

3. The method of claim 1, in which the second data defines the identity of the respective music file that the corresponding trusted computer has stored.

4. The method of claim 1, in which outputting information based on the set of second data received from each trusted computer comprises:
outputting, for each unique music file, a number of trusted computers which stored the unique music file.

5. The method of claim 1, in which outputting information based on the set of second data received from each trusted computer comprises:
outputting a total number of music files stored by the plurality of trusted computers.

6. The method of claim 5, in which outputting the total number of music files stored by the plurality of trusted computers comprises:
outputting a total number of music files stored by the plurality of trusted computers during a predetermined period of time.

7. The method of claim 1, in which outputting information based on the set of second data received from each trusted computer comprises:
outputting an average number of music files stored by the plurality of trusted computers during a predetermined period of time.

8. The method of claim 1, in which outputting information based on the set of second data received from each trusted computer comprises:
outputting a total number of music files that had not been purchased but were downloaded by trusted computers.

9. The method of claim 1, in which outputting information based on the set of second data received from each trusted computer comprises:
outputting an average number of music files that had not been purchased but were downloaded by trusted computers during a predetermined period of time.

10. An apparatus comprising:
a microprocessor; and
a memory in communication with the microprocessor, wherein the memory stores a program that, when executed by the microprocessor, instructs the microprocessor to perform the method of claim 1.

11. A general-purpose computer that is programmed to communicate with at least one apparatus defined by claim 10.

12. The general-purpose computer of claim 11, wherein the general-purpose computer is programmed to communicate with a plurality of apparatus defined by claim 10, thereby each of the apparatus receives a respective set of second data from a corresponding plurality of trusted computers.

13. The general-purpose computer of claim 12, wherein the general-purpose computer is programmed to output information comparing
at least one of the respective sets of second data
with
another of the respective sets of second data.

14. The general-purpose computer of claim 13, wherein the general-purpose computer is programmed to display information comparing
at least one of the respective sets of second data
with
another of the respective sets of second data.

15. The general-purpose computer of claim 14, wherein the general-purpose computer is programmed to display information comparing
a first total number of music files that had not been purchased but were downloaded by trusted computers, as indicated by at least one of the respective sets of second data
with
a second total number of music files that had not been purchased but were downloaded by trusted computers, as indicated by another of the respective sets of second data.

16. The general-purpose computer of claim 15, wherein the general-purpose computer is programmed to display information comparing
a first total number of music files stored by the corresponding plurality of trusted computers during a predetermined period of time, as indicated by at least one of the respective sets of second data
with
a second total number of music files stored by the corresponding plurality of trusted computers during a predetermined period of time, as indicated by another of the respective sets of second data.
